(19) United States
(12) Patent Application Publication
(10) Pub. No.: US 2026/0128031 A1
(43) Pub. Date: May 7, 2026

(54) METHODS AND SYSTEMS FOR AUDIO PROCESSING

(71) Applicant: Comcast Cable Communications, LLC, Philadelphia, PA (US)

(72) Inventors: Scott Kurtz, Philadelphia, PA (US); Philip Stick, Philadelphia, PA (US); Stephen Crowers, Philadelphia, PA (US)

(21) Appl. No.: 18/937,880

(22) Filed: Nov. 5, 2024

(51) Int. Cl. G10K 11/178

(52) U.S. Cl. CPC G10K 11/17825; G10K 11/17875; G10K 2210/3026; G10K 2210/3051; G10K 2210/505

(57) ABSTRACT

A speaker and a microphone may be disposed in separate devices, wherein each of the digital to analog converter that is driving the speaker and the analog to digital converter that drives the microphone are driven by separate clocks. The speaker may be instructed to send (e.g., output) a pilot signal dedicated to synchronization. The microphone may detect the pilot signal, convert it to a digital signal, and an echo canceller (and/or resampler device) may use the digital signal output by the microphone to synchronize the clocks driving the digital to analog converter associated with the speaker device and the analog to digital converter associated with the microphone device. One or more packets containing audio samples may be sent to the speaker and the echo canceller as well as one or more packets sent to the echo canceller from the microphone device may be used to determine clock error.

### BACKGROUND

Audio communication systems have become increasingly prevalent in various applications, from teleconferencing to voice-controlled devices. These systems often involve the use of microphones and speakers in close proximity, which can lead to acoustic feedback and echo issues. Echo occurs when a microphone picks up sound from a nearby speaker, causing the original audio to be re-transmitted and creating a distracting loop. To address this problem, audio echo cancellation techniques have been developed. These techniques typically involve analyzing the audio output from a speaker and subtracting any detected echo from the microphone input. However, effective echo cancellation relies on precise timing and synchronization between the speaker output and microphone input signals.

In many audio systems, the speaker and microphone are driven by separate clocks. Over time, these clocks are subject to error and may drift relative to each other, leading to a misalignment between the speaker and microphone signals. This clock drift (or clock error) can significantly degrade the performance of echo cancellation algorithms, as they rely on accurate timing to identify and remove echo components. The issue of clock drift is particularly challenging in distributed audio systems, where the speaker and microphone may be physically separated and driven by independent clock sources. As the drift accumulates over time, it can lead to noticeable audio quality degradation and reduced effectiveness of echo cancellation.

Existing approaches to addressing clock drift in audio systems often involve complex hardware solutions or frequent recalibration procedures. These methods can be costly, impractical for certain applications, or disruptive to the user experience. Additionally, some solutions may not be suitable for real-time audio processing, where low latency is critical. As audio communication continues to play an increasingly important role in various technologies, there is a growing need for improved methods of maintaining synchronization between audio components and ensuring robust echo cancellation performance in the presence of clock errors such as drift.

### SUMMARY

It is to be understood that both the following general description and the following detailed description are exemplary and explanatory only and are not restrictive. Methods and systems for audio processing are described. An audio output device driven by a first clock may be configured to receive a first digital signal and convert and output the digital signal as a pilot tone. An audio detection device driven by a second clock may be configured to receive the pilot tone and send a digital version of the received pilot tone. A variation in the pilot tone may be used to determine a clock error between the first clock and second clock and corrective measures may be taken to synchronize the first clock and second clock.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 shows an example system;

FIGS. 2A-2B shows an example diagram of a device with speaker and microphone, its acoustic environment and a remote user who may experience echo;

FIG. 3A shows an example diagram of analog to digital conversion;

FIG. 3B shows an example diagram of digital to analog conversion;

FIG. 4A shows an example method of analog to digital conversion and digital to analog conversion wherein the two conversions share the same clock;

FIG. 4B shows an example method of analog to digital conversion and digital to analog conversion wherein the two conversions do not share the same clock;

FIG. 5A shows an example method of analog to digital conversion and digital to analog conversion wherein the two conversions are clocked using different clocks;

FIG. 5B shows an example of the effect of echo cancellation when speaker and microphone clocks are synchronized;

FIG. 6A shows an example system and method for estimating clock difference using a zero crossing count method;

FIG. 6B shows an example system and example method for estimating clock difference using phase trajectory estimation;

FIGS. 7A-7E show example phase diagrams;

FIG. 8 shows an example system that estimates clock error and corrects for it using a fractional sampling rate converter;

FIGS. 9A-9B show example phase diagrams with samples indicated;

FIG. 10 shows an example system comprising a buffer;

FIG. 11 shows an example system for correcting long term error;

FIG. 12 shows an example system;

FIGS. 13A-13C show example error estimate diagrams;

FIG. 14 shows an example system;

FIG. 15 shows an example system;

FIG. 16 shows an example system;

FIG. 17 shows an example system;

FIG. 18 shows an example method;

FIG. 19 shows an example method;

FIG. 20 shows an example method;

FIG. 21 shows an example method;

FIG. 22 shows an example method;

FIG. 23 shows an example method; and

FIG. 24 shows an example system.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special-purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

“Content items,” as the phrase is used herein, may also be referred to as “content,” “content data,” “content information,” “content asset,” “multimedia asset data file,” or simply “data” or “information”. Content items may be any information or data that may be licensed to one or more individuals (or other entities, such as business or group). Content may be electronic representations of video, audio, text and/or graphics, which may be but is not limited to electronic representations of videos, movies, or other multimedia, which may be but is not limited to data files adhering to MPEG2, MPEG, MPEG4 UHD, HDR, 4 k, Adobe® Flash® Video (.FLV) format or some other video file format whether such format is presently known or developed in the future. The content items described herein may be electronic representations of music, spoken words, or other audio, which may be but is not limited to data files adhering to the MPEG-1 Audio Layer 3 (.MP3) format, Adobe®, CableLabs 1.0, 1.1, 3.0, AVC, HEVC, H.264, Nielsen watermarks, V-chip data and Secondary Audio Programs (SAP). Sound Document (.ASND) format or some other format configured to store electronic audio whether such format is presently known or developed in the future. In some cases, content may be data files adhering to the following formats: Portable Document Format (.PDF), Electronic Publication (.EPUB) format created by the International Digital Publishing Forum (IDPF), JPEG (.JPG) format, Portable Network Graphics (.PNG) format, dynamic ad insertion data (.csv), Adobe® Photoshop® (.PSD) format or some other format for electronically storing text, graphics and/or other information whether such format is presently known or developed in the future. Content items may be any combination of the above-described formats.

“Consuming content” or the “consumption of content,” as those phrases are used herein, may also be referred to as “accessing” content, “providing” content, “viewing” content, “listening” to content, “rendering” content, or “playing” content, among other things. In some cases, the particular term utilized may be dependent on the context in which it is used. Consuming video may also be referred to as viewing or playing the video. Consuming audio may also be referred to as listening to or playing the audio.

This detailed description may refer to a given entity performing some action. It should be understood that this language may in some cases mean that a system (e.g., a computer) owned and/or controlled by the given entity is actually performing the action.

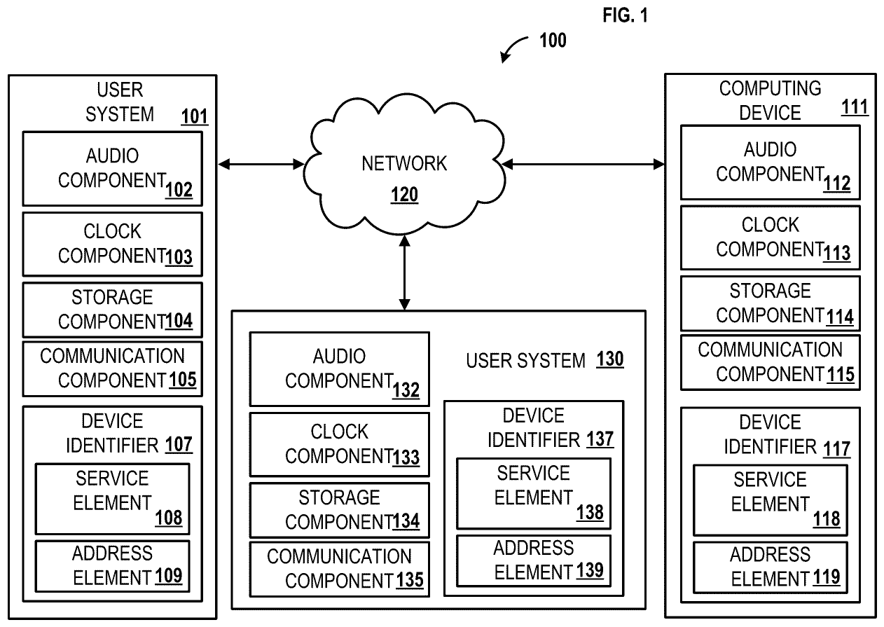

FIG. 1 shows an example system 100. The system 100 may comprise a user system 101 (e.g., comprising at least one first speaker device and at least one first microphone device, etc.), a user system 130 (e.g., comprising at least one second speaker device and at least one second microphone device.), a computing device 111 (e.g., a computer, a server, a content source, etc.), and a network 120. Each of the user devices may comprise one or more speakers and one or more microphones. Within each of user system 101 and user system 130, the one or more speaker devices may be instructed to send a pilot signal dedicated to synchronization. The pilot signal may be originated at the one or more speaker devices in digital form, and then converted to analog form for output by the one or more speaker devices. The analog audio signal is then received by (e.g., detected by) the one or more microphones proximate the one or more speakers, and converted to a digital signal. The digital form of the dedicated pilot signal is then used to synchronize the clocks of the speaker and microphone devices within the user systems, and perform echo cancellation.

The network 120 may be a network such as the Internet, a wide area network, a local area network, a cellular network, a satellite network, and the like. Various forms of communications may occur via the network 120. The network 120 may comprise wired and wireless telecommunication channels, and wired and wireless communication techniques. For the purposes of explanation, the user device 101 may be a first user device and may comprise, for example, a first microphone device and a first speaker device. The user device 130 may be a second user device may comprise a second microphone device and a second speaker device.

The user device 101 may comprise an audio component 102, a clock component 103, a storage component 104, a communication component 105, a network condition component 106, a device identifier 107, a service element 108, and an address element 109. The communications component 105 may be configured to communicate with (e.g., send and receive data to and from) other devices such as the computing device 111 via the network 120.

The audio component 102 may be configured to receive, process, store, and output audio data. The user device 101 may comprise, for example, one or more microphones configured to detect audio. The audio component may comprise, for example, one or more speakers. The one or more speakers may be configured to output For example, a user may interact with the user device by pressing a button, speaking a wake word, or otherwise taking some action which activates the voice-enabled device. The audio data may comprise or otherwise be associated with one or more utterances, one or more phonemes, one or more words, one or more phrases, one or more sentences, combinations thereof, and the like spoken by a user. The user device 101 may send the audio data to the computing device 111. The computing device 111 may receive the audio data (e.g., via the communications component 105). The computing device 111 may process the audio data. Processing the audio data may comprise analog to digital conversion, digital signal processing, natural language processing, natural language understanding, sending or receiving one or more queries, executing one or more commands, filtering, noise reduction, combinations thereof, and the like. The audio analysis component 102 may be configured for automatic speech recognition (“ASR”). The audio analysis component 102 may apply one or more voice recognition algorithms to the received audio (e.g., speech, etc.) to determine one or more phonemes, phonetic sounds, words, portions thereof, combinations thereof, and the like.

The audio component 102 may determine audio originating from a user speaking in proximity to the user device 101. The one or more audio inputs may be speech that originates from and/or may be caused by a user, a device (e.g., a television, a radio, a computing device, etc.), and/or the like.

The audio component 102 may comprise an automatic speech recognition (“ASR”) systems configured to convert speech into text. As used herein, the term “speech recognition” refers not only to the process of converting a speech (audio) signal to a sequence of words or a representation thereof (text), but also to using Natural Language Understanding (NLU) processes to understand and make sense of a user utterance. The ASR system may employ an ASR engine to recognize speech. The ASR engine may perform a search among the possible utterances that may be spoken by using models, such as an acoustic model and a language model. In performing the search, the ASR engine may limit its search to some subset of all the possible utterances that may be spoken to reduce the amount of time and computational resources needed to perform the speech recognition. ASR may be implemented on the user device 101, on the computing device 111, or any other suitable device. For example, the ASR engine may be hosted on the user device 101 or the computing device 111 that is accessible via the network 120. Various client devices may transmit audio data over the network to the server, which may recognize any speech therein and transmit corresponding text back to the client devices. This arrangement may enable ASR functionality to be provided on otherwise unsuitable devices despite their limitations. For example, after a user utterance is converted to text by the ASR, the server computer may employ a natural language understanding (NLU) process to interpret and understand the user utterance. After the NLU process interprets the user utterance, the server computer may employ application logic to respond to the user utterance. Depending on the translation of the user utterance, the application logic may request information from an external data source. In addition, the application logic may request an external logic process. Each of these processes contributes to the total latency perceived by a user between the end of a user utterance and the beginning of a response.

The clock component 103 may comprise a clock configured to drive a sampler of, for example, a microphone. The clock component may comprise a piezoelectric clock. The clock component may generate a stable clock signal. This clock signal serves as a reference for the sampling rate used to digitize an analog audio input (e.g., a voice), ensuring that the analog signal from the microphone is sampled at regular intervals with consistent precision and stability. As the analog signal is converted into a digital format using an Analog-to-Digital Converter (ADC), the timing of this conversion process is synchronized with the clock signal, maintaining accurate representation of the analog waveform. Subsequently, various digital signal processing algorithms, such as noise reduction and echo cancellation, rely on precise timing intervals provided by the clock signal for their operation. After processing, the digital voice signal is transmitted over a network, with the timing of data transmission synchronized with the clock signal.

The user device 130 may comprise an audio component 132, a clock component 133, a storage component 134, a communication component 135, a network condition component 136, a device identifier 137, a service element 138, and an address element 139. The communications component 135 may be configured to communicate with (e.g., send and receive data to and from) other devices such as the computing device 111 via the network 120.

The audio component 132 may be configured to receive, process, store, and output audio data. The user device 130 may comprise, for example, one or more microphones configured to detect audio. For example, a user may interact with the user device by pressing a button, speaking a wake word, or otherwise taking some action which activates the voice-enabled device. The audio data may comprise or otherwise be associated with one or more utterances, one or more phonemes, one or more words, one or more phrases, one or more sentences, combinations thereof, and the like spoken by a user. The user device 131 may send the audio data to the computing device 111. The computing device 111 may receive the audio data (e.g., via the communications component 105). The computing device 111 may process the audio data. Processing the audio data may comprise analog to digital conversion, digital signal processing, natural language processing, natural language understanding, sending or receiving one or more queries, executing one or more commands, filtering, noise reduction, combinations thereof, and the like. The audio component 132 may be configured for automatic speech recognition (“ASR”). The audio component 132 may apply one or more voice recognition algorithms to the received audio (e.g., speech, etc.) to determine one or more phonemes, phonetic sounds, words, portions thereof, combinations thereof, and the like.

The audio component 132 may determine audio originating from a user speaking in proximity to the user device 130. The one or more audio inputs may be speech that originates from and/or may be caused by a user, a device (e.g., a television, a radio, a computing device, etc.), and/or the like.

The audio component 132 may comprise an automatic speech recognition (“ASR”) systems configured to convert speech into text. As used herein, the term “speech recognition” refers not only to the process of converting a speech (audio) signal to a sequence of words or a representation thereof (text), but also to using Natural Language Understanding (NLU) processes to understand and make sense of a user utterance. The ASR system may employ an ASR engine to recognize speech. The ASR engine may perform a search among the possible utterances that may be spoken by using models, such as an acoustic model and a language model. In performing the search, the ASR engine may limit its search to some subset of all the possible utterances that may be spoken to reduce the amount of time and computational resources needed to perform the speech recognition. ASR may be implemented on the user device 130, on the computing device 111, or any other suitable device. For example, the ASR engine may be hosted on the user device 101 or the computing device 111 that is accessible via the network 120. Various client devices may transmit audio data over the network to the server, which may recognize any speech therein and transmit corresponding text back to the client devices. This arrangement may enable ASR functionality to be provided on otherwise unsuitable devices despite their limitations. For example, after a user utterance is converted to text by the ASR, the server computer may employ a natural language understanding (NLU) process to interpret and understand the user utterance. After the NLU process interprets the user utterance, the server computer may employ application logic to respond to the user utterance. Depending on the translation of the user utterance, the application logic may request information from an external data source. In addition, the application logic may request an external logic process. Each of these processes contributes to the total latency perceived by a user between the end of a user utterance and the beginning of a response.

The clock component 133 may comprise a clock configured to drive a sampler of, for example, a microphone. The clock component may comprise a piezoelectric clock. The clock component may generate a stable clock signal.

This clock signal serves as a reference for the sampling rate used to digitize an analog audio input (e.g., a voice), ensuring that the analog signal from the microphone is sampled at regular intervals with consistent precision and stability. As the analog signal is converted into a digital format using an Analog-to-Digital Converter (ADC), the timing of this conversion process is synchronized with the clock signal, maintaining accurate representation of the analog waveform. Subsequently, various digital signal processing algorithms, such as noise reduction and echo cancellation, rely on precise timing intervals provided by the clock signal for their operation. After processing, the digital voice signal is transmitted over a network, with the timing of data transmission synchronized with the clock signal.

The one or more speaker devices may be instructed to send a pilot signal dedicated to synchronization. The pilot signal may be originated at the one or more devices in digital form, and then converted to analog form for output by the one or more speaker devices. The analog audio signal is then received by the one or more microphones, and converted to a digital signal. The digital form of the dedicated pilot signal is then used to synchronize the clocks of the speaker and microphone devices, and perform echo cancellation.

The computing device 111 may comprise an audio component 112, a clock component 113, a storage component 114, a communications component 115, a device identifier 117, a service element 118, and an address element 119.

The audio component 112 may be configured to receive audio data from either or both of the user device 101 and the user device 130. The audio component 112 may comprise, for example, a frequency estimator, a resample, and/or an acoustic echo canceller as described herein.

The clock component 113 may be configured to adjust one or more a sample rate or other operating parameter associated with either or both of the user device and/or the user device 130.

The storage component 114 may be configured to store audio profile data associated with one or more audio profiles associated with one or more audio sources (e.g., one or more users). An audio profile may comprise an echo cancellation profile indicating, for example, an echo cancellation estimate associated with a user and/or a location. For example, a first audio profile of the one or more audio profiles may be associated with a first user of the one or more users. Similarly, a second audio profile of the one or more audio profiles may be associated with a second user of the one or more users. The one or more audio profiles may comprise historical audio data such as voice signatures or other characteristics associated with the one or more users. For example, the one or more audio profiles may be determined (e.g., created, stored, recorded) during configuration or may be received (e.g., imported) from storage.

The audio component 112 may comprise or otherwise be in communication with the one or more microphones. The one or more microphones may be configured to receive the one or more audio inputs. The audio component 112 may be configured to detect the one or more audio inputs. The one or more audio inputs may comprise audio originating from (e.g., caused by) one or more audio sources. The one or more audio sources may comprise, for example, one or more people, one or more devices, one or more machines, combinations thereof, and the like. The audio component 112 may be configured to convert the analog signal to a digital signal. For example, the audio component 112 may comprise an analog to digital converter.

For example, the audio component 112 may determine audio originating from a user speaking in proximity to the user device 111. The one or more audio inputs may be speech that originates from and/or may be caused by a user, a device (e.g., a television, a radio, a computing device, etc.), and/or the like.

The device identifier 117 may have a service element 118 and an address element 119. The service element 118 may have or provide an internet protocol address, a network address, a media access control (MAC) address, an Internet address, or the like. The address service 118 may be relied upon to establish a communication session between the computing device 111, the user device 101, or other devices and/or networks. The address element 119 may be used as an identifier or locator of the user device 101. The address element 119 may be persistent for a particular network (e.g., network 120, etc.).

The service element 118 may identify a service provider associated with the computing device 111 and/or with the class of the computing device 111. The class of the computing device 111 may be related to a type of device, a capability of a device, a type of service being provided, and/or a level of service (e.g., business class, service tier, service package, etc.). The service element 118 may have information relating to and/or provided by a communication service provider (e.g., Internet service provider) that is providing or enabling data flow such as communication services to the computing device 111. The service element 118 may have information relating to a preferred service provider for one or more particular services relating to the computing device 111. The address element 119 may be used to identify or retrieve data from the service element 118, or vice versa. One or more of the address element 119 and the service element 118 may be stored remotely from the computing device 111 and retrieved by one or more devices such as the computing device 111, the user device 101, or any other device. Other information may be represented by the service element 118.

The computing device 111 may include a communication component 115 for providing an interface to a user to interact with the user device 101. The communication component 115 may be any interface for presenting and/or receiving information to/from the user, such as user feedback. An interface may be communication interface such as a television (e.g., voice control device such as a remote, navigable menu or similar), web browser (e.g., Internet Explorer®, Mozilla Firefox®, Google Chrome®, Safari®, or the like). The communication component 115 may request or query various files from a local source and/or a remote source. The communication component 115 may transmit and/or data, such as audio content, telemetry data, network status information, and/or the like to a local or remote device such as the user device 101. For example, the user device may interact with a user via a speaker configured to sound alert tones or audio messages. The user device may be configured to displays a microphone icon when it is determined that a user is speaking. The user device may be configured to display or otherwise output one or more error messages or other feedback based on what the user has said.

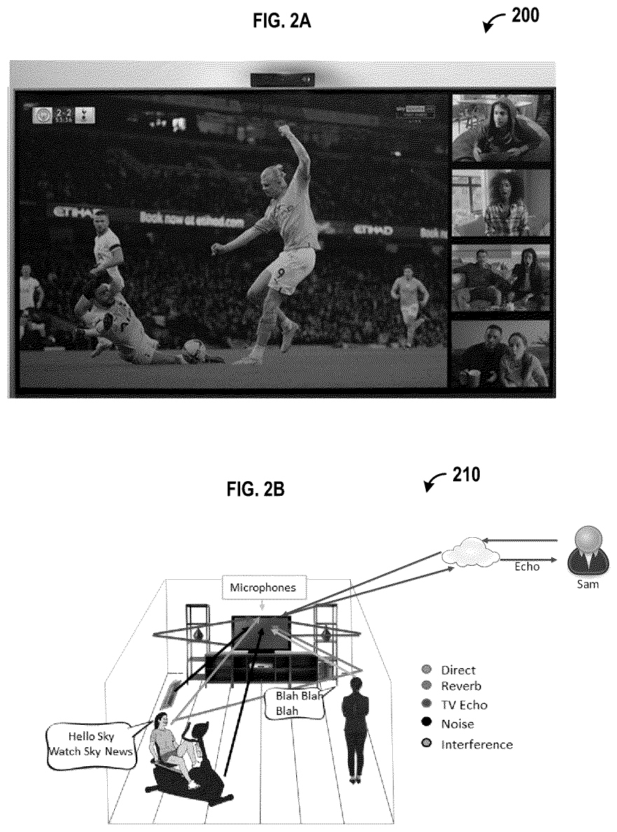

FIG. 2A shows an example system 200. The system 200 may be configured for interactive (e.g., social) content consumption. The system may comprise one or more media devices (e.g., one or more speaker devices, one or more televisions, one or more computers), and one or more user devices (e.g., one or more microphone devices). For example, the one or more media devices may comprise one or more speaker devices. For example, the one or more user devices may comprise one or more microphone devices. The one or more speaker devices may be instructed to send a pilot signal dedicated to synchronization. The pilot signal may be originated at the one or more devices in digital form, and then converted to analog form for output by the one or more speaker devices. The analog audio signal is then received by the one or more microphones, and converted to a digital signal. The digital form of the dedicated pilot signal is then used to synchronize the clocks of the speaker and microphone devices, and perform echo cancellation.

The one or more media devices may be configured to output media. The one or more user devices may be configured to receive one or more user inputs, capture image data, detect audio data, combinations thereof, and the like.

For example, in FIG. 2A, only one media device is shown, but the system ostensibly comprises four more media devices associated with the four viewing panes on the right of the media device. Similarly, the FIG. 2A shows only one user device (affixed atop the media device), the system comprises four additional user devices, each associate with a viewing pane of the four viewing panes shown on the right of the media device.

FIG. 2B shows an example system 210. The system 210 may be configured to detect and transmit audio data. For example, one or more analog audio signals may be detected by the one or more microphone devices. The one or more analog audio signals may comprise, for example, direct audio, reverb audio, echo audio, noise audio, interference audio, combinations thereof, and the like. FIG. 2B shows one or more acoustic paths between, for example, one or more speaker devices and one or more microphone devices. A first user (labeled Sam) may speak into a microphone device of the one or more microphone devices, Sam's speech may be output by the one or more speaker devices. At least one microphone device of the one or more microphone devices that is proximate the one or more devices may detect Sam's speech output and send the detected speech output back to Sam. Due to the delay between the Sam's speech and the returned speech, Sam perceives the returned speech as echo.

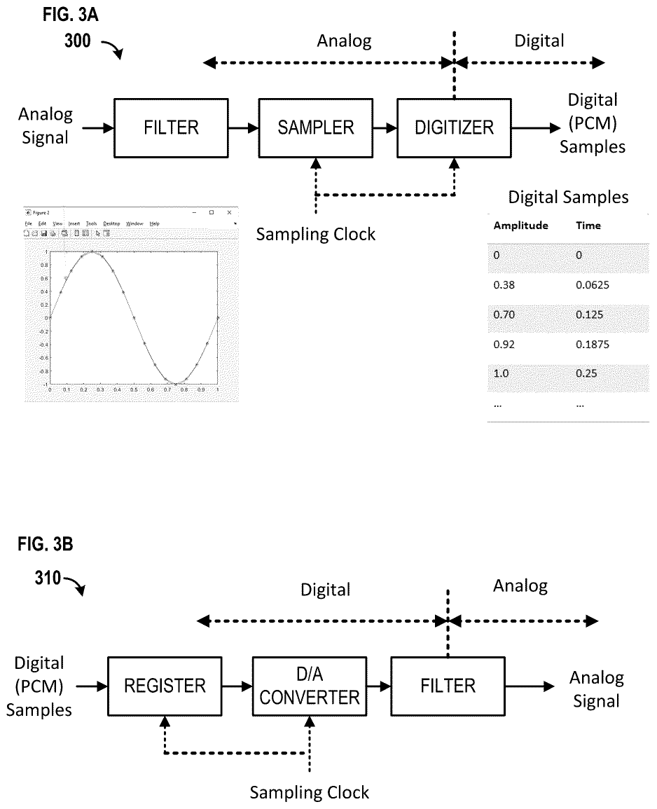

FIG. 3A shows a system 300 configured for converting analog signal to digital signals. In analog to digital conversion, the sampling clock feeds the sampler to control when the sampler takes a nearly instantaneous snapshot of the amplitude of the filtered signal. Once a snapshot is taken, the digitizer converts the amplitude to a number. The digital samples may be referred to as Pulse Code Modulated (PCM) samples.

FIG. 3B shows a system 310 configured for converting digital signals to analog signals. At the left is a stream of PCM samples. The sampling clock feeds a register. At each clock period, the register is fed a new PCM sample. The PCM sample in the register represents an amplitude. The Convert to Analog block converts the PCM sample to analog. The output of the converter is still sampled (not continuous) but rather than being a number it is a voltage. The output of the “Convert to Analog” block is fed to a filter, which transforms the sequence of pulses of voltages into a continuous analog signal.

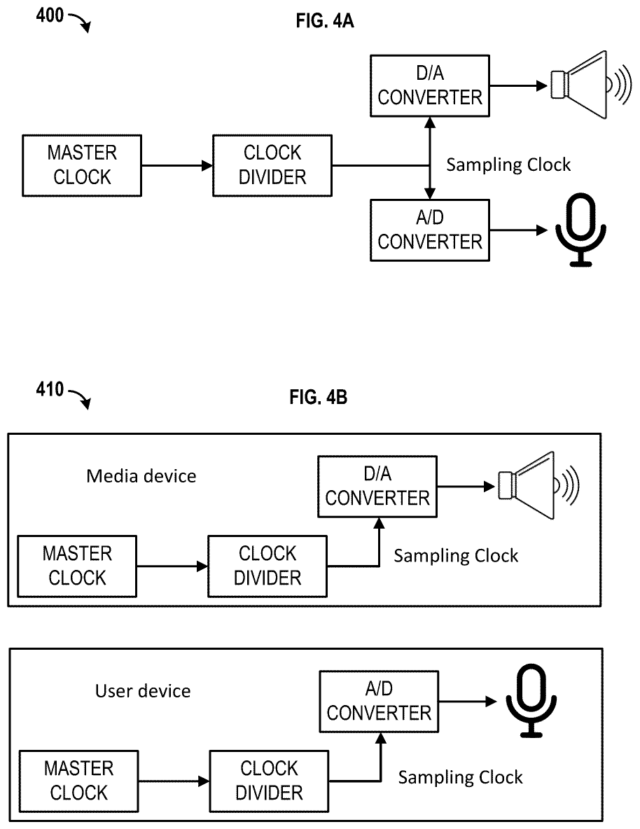

FIG. 4A shows an example system 400. The example system may comprise a master clock, a clock divider, a digital-to-analog converter (DAC) and an analog-to-digital converter (ADC). The DAC may be associated with a speaker device and the ADC may be associated with a microphone device. In FIG. 4A, each of the DAC and ADC are driven by the same master clock. Thus, the sampling clock (the speaker clock) that drives the D/A converter that drives the speaker(s) is derived from the same clock as the sampling clock (microphone clock) that drives the A/D converter that converts the microphone signal(s) from analog to digital. In the case where a PDM (Pulse Division Multiplexed) microphone is used, the speaker clock may be derived from the same clock as the PDM microphone's bit clock. FIG. 4B shows a system 410 similar to the system 400 but the microphone and speaker may be driven by different clocks. Specifically, FIG. 4B, shows one media device (TV) and one user device (e.g., camera device, audio device), each comprise (and are driven by) their own clock. The system 410 may be configured to echo cancellation as described herein. When the speaker device (TV) and microphone device (camera) don't share a common clock, the speaker device sampling clock and the microphone device sampling clocks are not locked. Thus, the D/A and A/D converter sampling frequencies may be slightly different. Therefore, there will be no phase lock between the two devices and, in fact, over time the number of speaker samples and the number of microphone samples may not be the same.

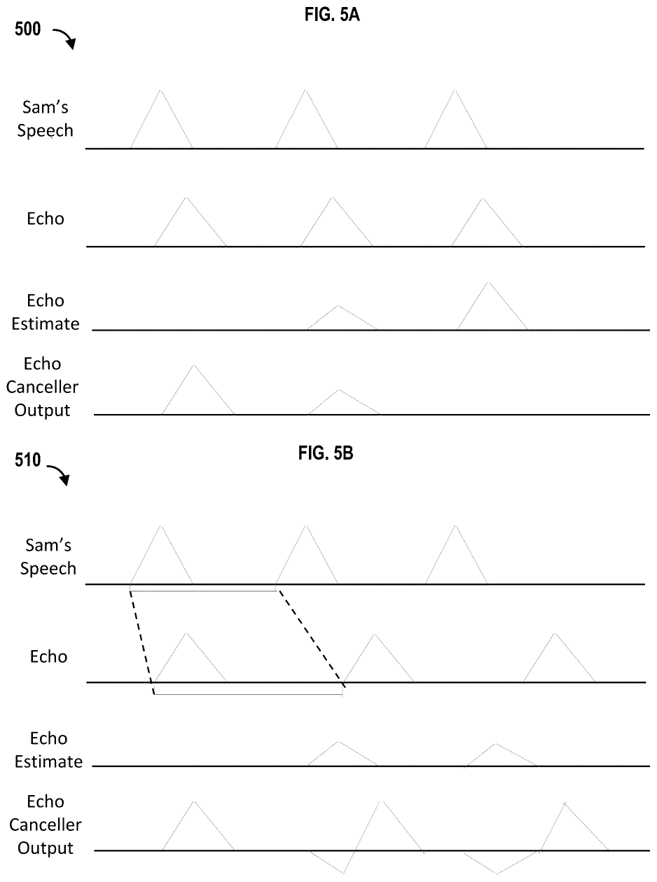

FIG. 5A shows an example echo cancellation 500. Referring back to FIG. 2B, when Sam speaks, the signal is fed through an active echo canceler (AEC) as the “reference signal” to the speaker. The signal travels from speaker to microphone (directly and with reflections) and the resulting signal is sent back to Sam, through the bottom path of the echo canceller. If not for the echo canceller, Sam would hear echo. The top plot of FIG. 5A shows Sam's speech as amplitude vs. time. The second plot of FIG. 5A shows Sam's speech reflected back from the speaker to the microphone (e.g., Sam's speech as detected by the microphone proximate the speaker that output Sam's speech). The third plot of FIG. 5A shows an echo estimate. Echo canceler adjust the echo estimate as time passes and thus “converge” on an actual echo. In the third plot, the echo estimate starts at a “0” value (e.g., “unconverged), increases to approximately half the echo, and then ultimately converges to the actual echo. The fourth plot of FIG. 5A shows an echo canceller output, which is the actual echo minus the echo estimate. As seen in the fourth plot, the first echo canceller output is Sam's speech, but delayed (e.g., time is on x-axis). The second echo canceller output is less of Sam's speech, and finally the echo canceller output has none of Sam's speech in it. As the echo canceller converges, the degree to which it can remove echo increases and eventually there is little to no echo at the output of the echo canceller. An echo canceller's performance is measured by how much echo reduction it can achieve. Echo reduction is referred to as Echo Return Loss Enhancement (ERLE). When an echo canceller starts up, the ERLE is typically zero. Over time the echo canceller's adaptive filter converges and eventually reaches its best ERLE. Convergence is the process of adapting the filter so that the filter's impulse response is an estimate of the impulse response of the acoustic path between the one or more speaker devices and the one or more microphone devices.

As shown in FIG. 5B, when the echo canceller clock (the microphone clock) has a different sample frequency and is not phase locked (e.g., is not synched) with the speaker clock, over time, the lag between speech and echo increases and prevents the echo canceller from converging, which in turn results in a poor echo estimate and echo bleeding through to the echo canceller output (as seen in the bottom plot of FIG. 5B).

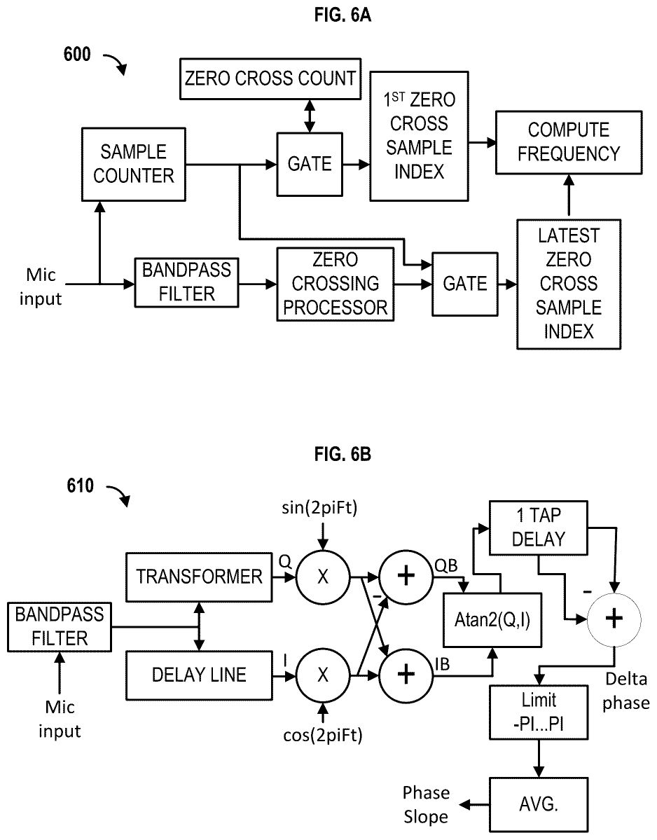

FIG. 6 shows an example system 600 configured to carry out a zero-crossing method of frequency error estimation. The zero-crossing method begins with a continuous sinusoid with frequency f. The formula that represents the time varying amplitude of this signal is:

$$s ( t ) = A sin ( 2 π ft )$$

where t represents time in seconds, s(t) represents the pilot tone being played out of the speaker, amplitude as a function of time, f is the frequency, and A is the amplitude. For the purposes of description, this example assumes an amplitude A=1. In the system 600, a speaker sampling clock may be the reference clock, and a microphone clock may be experiencing clock error.

A digital version of the speaker signal may be determined by sampling an analog signal. As an example, the sampling rate may be Fss (speaker sampling rate) in samples per second. As an example, the speaker sampling rate may be 48 kHz. The sampling period is the inverse of the sampling rate or Tss=1/Fss=1/48000=20.8333333 microseconds. That means that an amplitude of the analog signal s(t) is determined every of every 20.8333333 microseconds. To note, the frequency f of the pilot tone is not the same thing as the sampling rate. For the purposes of explanation and as an example, a pilot tone may be 2400 Hz or 2400 cycles per second (e.g., it will complete 2400 cycles of a sinusoid in one second). But in one second, the signal will be sampled at a rate of 48000 samples per second. That means that each cycle of the 2400 Hz tone will be sampled 20 times per cycle. Thus, the sampled speaker signal may be represented as:

$$s ( n ) = sin ( 2 π nfTss )$$

To determine the number of samples per cycle of the 2400 Hz sinusoid, it is assumed that one cycle of sin(x) completes when x=2pi.

$$\begin{matrix}x = 2 π nfTss \\ 2 π = 2 π nfTss \\ n = \frac{1}{fTss}\end{matrix}$$

Replacing Tss with 1/Fss

$$n = \frac{Fss}{f} = \frac{48000}{2400} = 20 samples per cycle$$

From the point of view of the microphone device, the acoustic (e.g., environmental signal) signal travels to the microphone is converted to an analog signal, and is sampled at Fsm to generate a digital signal, where Fsm is slightly different (e.g., by virtue of the microphone being driven by a different clock than the speaker) from the speaker's sampling rate of Fss and an associated sampling period of Tsm, which is the inverse of Fss. For example, Fsm may be 48010 Hz, and Tsm is 20.829 microseconds.

Thus, the digitized microphone signal may be represented as:

$$m ( n ) = sin ( 2 π nfTsm )$$

and the number of microphone samples per cycle is

$$n = \frac{Fsm}{f} = \frac{48010}{2400} = 20.0 \; 0416667 samples per cycle$$

Cycles per elapsed time can be determined. For example, an expected number of cycles of elapsed time may be defined as t=f*t=2400*t where t=100=elapsed time, f=2400 Hz=pilot tone, Fss (speaker sampling rate)=4800 Hz, and Fsm (microphone sampling rate)=48010 Hz. Thus, the number of cycles over 100 seconds at the speaker side is 2400*100=240,000 cycles/100 seconds and the number of cycles over the same 100 seconds at the microphone is 2400*100*48,000/48,010=239,995 cycles/100 seconds.

Thus, by comparing the number of cycles at the speaker and the microphone, clock error may be determined. For example, f may be the estimated pilot tone, and represented as:

$${f}^{′} = \frac{NZC}{Elapsed Samples} * Fss$$

where NZC is the number of negative to positive zero crossings over a given period of time (e.g., the number of cycles). Therefore, the difference between the measured frequency at the microphone and the expected frequency may be represented as:

$$Δ f = f - {f}^{′}$$

The difference between the two may be expressed in parts per million (ppm) where

$$Δ fppm = \frac{Δ f}{f} * 1 e 6$$

The difference in ppm between the speaker and mic clocks will be the same as Δfppm. Given that, we can compute the difference between the speaker and microphone sampling clocks as:

$$Δ Fs = \frac{Δ fppm * Fsm}{1 e 6}$$

The systems and methods of FIG. 6 may be configured for error correction. For example, errors may be caused if there is a non-integer number of cycles (e.g., negative to positive zero crossings) in a given time. The error may be addressed by interpolating zero crossing locations. Because the slope of a given sine wave in the region of a zero crossing is relatively constant, linear interpolation may be used between points on the sine wave near the zero crossing to estimate a location of a zero crossing between sample periods. For example, slope may be described in units of change of amplitude as:

$$slope = s ( n ) - s ( n - 1 )$$

where s(n) is the amplitude of the first sample after a negative to positive zero crossing, s(n−1) is the amplitude of the sample immediately preceding a negative to positive zero crossing.

The estimated zero crossing location (zc) may be:

$$zc = s ( n ) - \frac{s ( n - 1 )}{slope}$$

Referring back to

$${f}^{′} = \frac{NZC}{Elapsed Samples} * Fss$$

Elapsed samples may be computed using the interpolated zero crossing location. The elapsed sample count may be started at the first interpolated zero crossing, and the most recent zero crossing also as the interpolated zero crossing. For example, if the first zero cursing occurs between sample 100 and sample 101, the actual zero crossing may be estimated by interpolating that the actual zero crossing occurs at “sample” 100.25. For example, if the most recent zero crossing occurs between sample 100,000 and sample 100,001, it may be estimated by interpolation that the actual zero crossing occurs at 100,000.75. Therefore, the elapsed number of samples is 99,900.5 samples rather than 99,900 or 99,901 samples. Thus, the number of elapsed samples is the difference between the two. A bandpass filter may be used to allow the pilot tone through but to eliminate noise and other interference. Thus, generally speaking, with respect to sampling a sinusoid, if the sampling rate is higher than it should be (e.g., due to clock error), the sampling period decreases and the samples are taken at smaller intervals. Thus, for the same number of samples, the above formulae would (likely) result in a non-integer number of cycles. Similarly if the sampling rate were lower than it should be and the sampling period hence increased, the same number of samples would cover more than a single cycle (e.g., extending into a next cycle).

In the system of FIG. 6, a pilot tone (e.g., a single frequency sine wave analog signal) is output by speakers and detected by a microphone. The pilot tone may be broadcast at any time and any number of times. The microphone input is fed to a narrow bandpass filter whose center frequency is equal to the pilot frequency. This removes most of the noise and interference, which improves the accuracy of the frequency estimator and decreases the time required to make an accurate estimate of the frequency. The sample counter counts microphone input samples. The zero crossing detector detects negative to positive zero crossings in the filtered microphone signal. The Zero Cross Count block stores the number of zero crossing events, excluding the first one. When the first zero crossing occurs, the associated sample counter is stored in the “First Zero Cross Sample Index” block. Subsequent zero crossing events cause the sample count associated with the events in the “Latest Zero Crossing Sample Index” block. Upon each such event, the Compute Frequency block computes a new frequency estimate using the following formula:

$$Freq = \frac{Zero Cross Count}{\begin{matrix}LatestZeroCrossIndex - \\ FirstZeroCrossIndex\end{matrix}} Mic Sampling Frequency$$

To reduce error induced by quantizing the zero crossing timestamp at the microphone sampling period, the actual zero crossing time is estimated by interpolating between the samples surrounding the zero crossing event as follows:

$$Slope = Sample Amplitude - Prev Sample Amplitude$$

$$and$$

$$Interpolated Zero Cross Sample Index = Sample Count - \frac{Previous Sample Amplitude}{Slope}$$

The interpolated zero cross sample indices are used for both the First Zero Cross Index and the Latest Zero Cross Index.

FIG. 6B shows an example system 610 configured to carry out a phase trajectory method of frequency error estimation. The phase trajectory method uses a single frequency pilot tone as was the case in the previous example but the method for measuring the frequency of the pilot tone is different. This method relies on the fact that phase Θ of a sine wave as a function of time is linear.

$$sin ( 2 π ft ) = sin ( θ ( t ) )$$

$$θ ( t ) = 2 π ft$$

The phase vs. time is therefore a straight line with slope 2πf. Thus the frequency of the pilot tone as perceived by the microphone is determined by measuring the slope of phase of the microphone input signal. Once this measurement is made, the ppm error can be computed as above. The clock difference between the speaker and the microphone can be computed similarly to the zero crossing method described with respect to FIG. 6A. Similarly to the zero crossing method, a bandpass filter may be incorporated to remove noise and interference.

In the system of FIG. 6B and associated phase trajectory method makes use of the fact that frequency is the derivative of phase. Further, because the slope of a phase is proportional to frequency when the tone is pure (e.g., such as the pilot tone). In system 610 in FIG. 6A, The microphone input is filtered through a bandpass to remove out-of-band noise. Then, the filtered signal is broken down into its real (I) and imaginary (Q) components using the delay line and transformer (e.g., Hilbert transformer or other transforms). The resulting complex signal (I, Q) may be mixed down by the known pilot frequency, resulting in the complex signal IB, QB. Mixing may refer to modulation or multiplication of a signal by a sinusoid. When multiplying a signal by a sinusoid of frequency F, the resulting output has a copy of the spectrum of the signal shifted down by F Hz and a second image of that image shifted up by F Hz. This comes about because cos(x)*cos(y)=½*(cos(x+y)+cos(x−y)). When quadrature mixing is performed as is in FIG. 6B, the cos(x+y) component may be eliminated. Mixing the F Hz pilot tone may be mixed down to baseband (0 Hz) leaving a real and imaginary component (I and Q) that are then used to compute the phase.

The 4 quadrant arctangent of (I, Q) may be determined. A previous phase may be determined and used to compute phase change from one sample to the next (e.g., a delta phase). The delta phase may be limited to ensure it is between −π and π. The long term average reflects the phase slope over time. Thus, the frequency as perceived by the microphone (e.g., in Hz) may be described as:

$$Freq = Pilot Frequency + \frac{Phase Slope * Mic Sampling Rate}{2 * π}$$

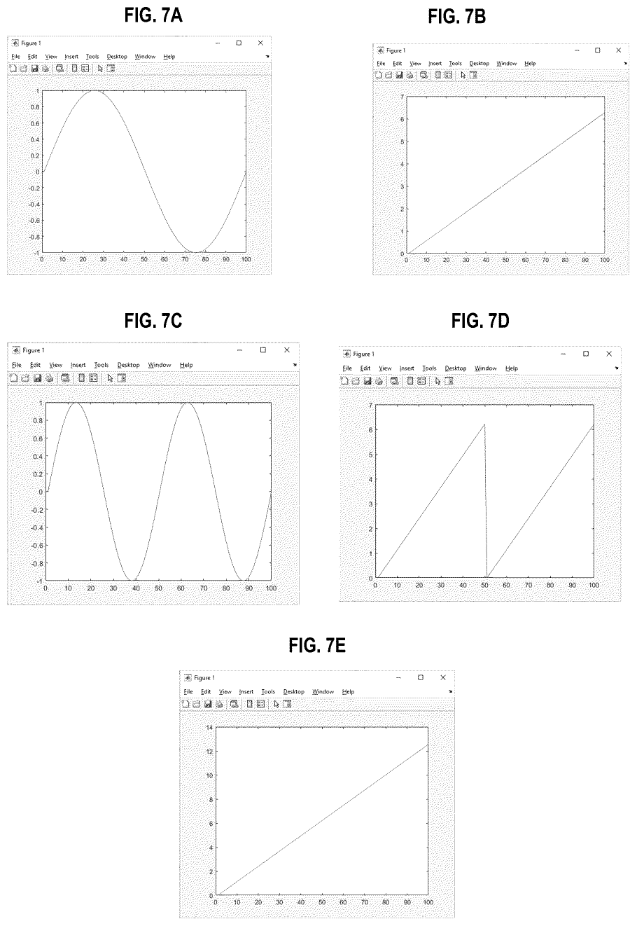

FIGS. 7A-7E show example plots related to the phase trajectory method described with respect to FIG. 6. FIG. 7A shows a plot of a single cycle of a sine wave 710. FIG. 7B shows a plot of the phase of the sine wave vs. time. In FIG. 7B, because the wave is a sine wave, zero phase is the first point in the plot and the phase increases linearly up to 2*pi at the end of the plot because it's a single cycle. FIG. 7C is a sine wave at twice the frequency and FIG. 7D shows the corresponding phase plot. The phase goes through two cycles of 0 to 2pi because there are two cycles of the sine wave. The slope of the phase (phase trajectory) reflects the frequency of the sine wave. In FIG. 7D, discontinuity half way through is because sine is a circular function. FIG. 7E shows a second phase plot is without the discontinuity—in this case with the phase going linearly from 0 to 4pi rather than 0 to 2pi and then again from 0 to 2pi. Recall that sin(x+2*n*pi)=sin(x).

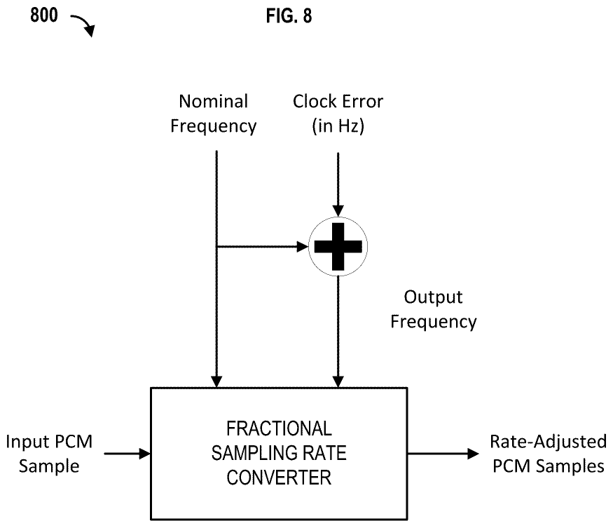

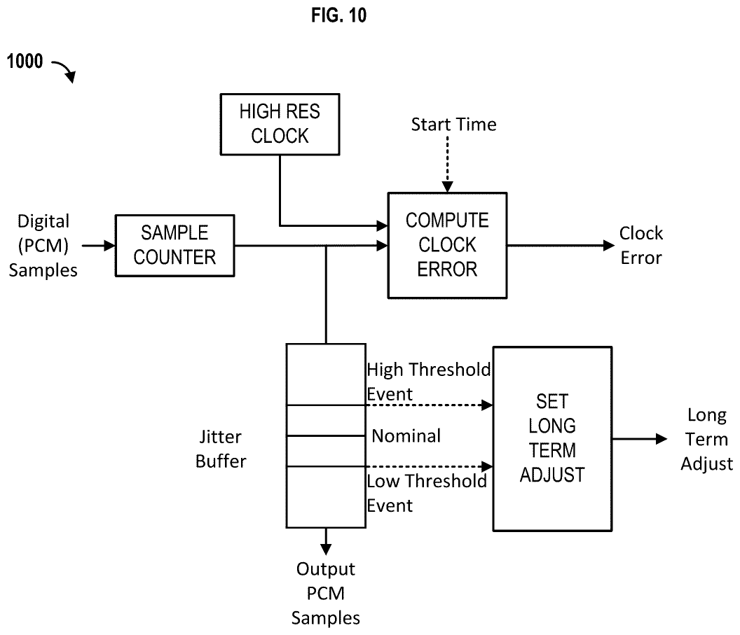

FIG. 8 shows sampling rate convert (e.g., a resampler, a fractional sampling rate converter). The sampling rate convert may receive a clock error (e.g., in Hz). The sampling rate converter may receive a nominal frequency (e.g., 16 kHz). The error may be added to or subtracted from the nominal frequency (as indicated by the “+”). So, for example, if the clock error is +1 Hz, and the nominal frequency is 16 kHz, the output frequency may be 16,001 Hz. Thus, if the input PCM samples are received at 16 kHz, the rate adjusted PCM samples would leave the convert at 16,0001 Hz. The rate adjusted PCM samples output may be fed to the buffer (as described in greater detail in FIG. 10). The rate adjusted PCM sampling rate may be used to interpolate the amplitude of a sample (e.g., estimate, at a given time point, an amplitude of a sample that would have occurred had the actual sampling rate not been subject to error based on the amplitude of one or more other samples). Thus, in order to synchronize the number of samples between the microphone and the speaker, an amplitude of a not received sample can be inferred using timing data from the fractional sampling rate converter. In other words, the clock error as determined based on the a high-resolution (e.g., real-time) clock, can inform the sampling rate converter which then dictates the inference of an amplitude of one or more samples that were not received within a given time frame due to clock error in either the A/D converter or D/A converter.

The sampling rate adjuster may be configured to adjust the sampling rate of the microphone and/or the sampling rate of the speaker audio. The resampler (the sampling rate adjuster) may be configured to take a sampled signal and resample it to have the same effect as if adjusting the sampling clock frequency. For purposes of explanation, the sampling rate adjuster will be described as if it were implemented on the microphone. Adjusting the sampling rate includes one or more static parameters such as the nominal microphone sampling rate (expressed as “NominalMicrophoneSamplingRate”) and the nominal speaker sampling rate. In addition there is a dynamic parameter—the clock error in parts per million initialization (expressed as “SpeakerClockErrorPPM Initialization), and for initializing the sampling rate converter, InputSamplingRate=NominalMicrophoneSamplingRate, and OutputSamplingRate=InputSamplingRate. To note, the clock error may not be associated with only the speaker clock. The clock error is the measured difference between the speaker clock and the microphone clock. The microphone and speaker nominal sampling rates may be fixed. The clock error may be a measurement that varies over time based upon an estimate of the clock error. This estimate may improve over time. As the estimate changes, the updated estimate may be fed to the resampler.

The method may comprise receiving one or more microphone buffer packets and modifying a sampling rate of either or both of the speaker and/or microphone using the sampling rate converter. If adjusting the microphone sampling rate, the adjusted rate will be: NominalSamplingRate*(1.0+SpeakerClockErrorPPM/1000000.0f). If adjusting the speaker sampling rate, the adjusted rate will be: NominalSamplingRate*(1.0−SpeakerClockErrorPPM/1000000.0f). The signs are based upon the assumption that the real-time clock reference is on the device with the microphone.

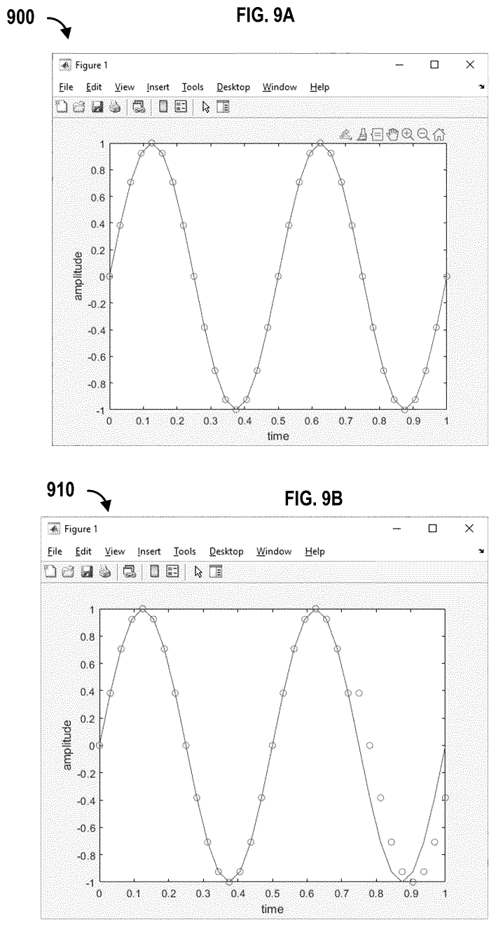

The resampler may be configured to input a sample PCM stream sampled at FSin and output a PCM stream sampled at FSout. In the case when FSout=n*FSin (interpolation) or FSout=FSin/m (decimation) or when FSout=n/m*FSin where n and m are integers, the method may comprise interpolating by a factor of n and decimating by a factor of m. However, when n/m is not a ratio of reasonably limited integers, but is instead, for example, a very small fraction, interpolation and decimation may not be practical. For example, it may be desirable to increase the sampling rate by 1 part per million. For example, n might equal 1,000,001 and m might equal 1,000,000. In such a case, it may be feasible to increase the sampling rate by 1 ppm by repeating a sample every 1,000,000 samples. However, that does not change the interval between samples. Because the process begins with sampled data, only samples at the input sampling rate may be available (e.g., samples of the signal between consecutive samples might be available). Thus, the present systems and methods may interpolate at such a high interpolation rate such that it may be affordable to occasionally vary by a sample over a given period of time without a large effect. For example, FIG. 9A shows an analog signal (sine wave) along with a sampled version (indicated by the circles). FIG. 9B shows the effect of inserting a sample (e.g., at 0.75 seconds). Thus, there is a discontinuity at 0.75 second. Therefore, beginning with samples that are more closely spaced together, it is possible to insert this type of discontinuity more often and with smaller effect. Thus, the present systems and methods may interpolate to a higher sampling rate and then move up or back one closely spaced sample at a rate that will achieve the desired output sampling rate.

FIG. 10 shows an example long term clock error (e.g., slip) estimator and buffer system. In this context, “slip” refers to the discrepancy or error in the timing of sampling due to clock error. The long term clock error estimator may be configured to estimate long term clock error. Long term clock error may occur because, for example, even if the sampling rate is adjusted to within. 1 parts per million error, clocks still drift over time. For example, for a sampling rate of 48 KHz and 0.1 ppm error, one sample every 208 seconds is slipped. If the error is 1 ppm, the process slips one sample every 20.8 seconds. For example, if the clock error is 50 ppm at 48 KHz sampling rate, the slip would be 2.5 samples per second! If it takes 5 minutes to adjust the clock, that comes to a 750 sample slip. If enough time elapses, the slippage can dramatically impact the echo cancellation process. Beyond that, we will see even more of a slip during the period when we first start the adjustment process.

The present methods and systems may be configured to correct for long-term slips. For example, a jitter buffer may be introduced into the stream of samples from the microphone. For example, long term clock error may be addressed by either using short term time scale modification where a number of fractional sample adjustments are made over a period of time (which causes the long-term extra samples to be “consumed,” or stretching out samples in order to make up for a long-term shortfall of samples.

For example, a method implemented with the system of FIG. 10 may begin with the case where a clock offset estimate is perfect and the resampler's (microphone resampler) sampling rate exactly matches the reference (speaker) sampling rate. In order to handle long-term drift and slips, a buffer may be introduced into the sample stream. At initialization, the buffer may be filled with zeros up to the nominal level. If the buffer falls below the low water mark, the sampling rate may be increased until (Nominal—Low Water Mark) samples have been added. If it falls above the high water mark, the sampling rate may be reduced until we have added (High Water Mark—Nominal) samples.

In this case, the depth of the buffer in samples should remain constant. If the clock offset estimate is off by 1 ppm, the depth of the buffer will increase or decrease by one sample every 20.8 seconds. By monitoring the depth of the buffer, it is possible to estimate how much error there is in the clock offset estimate. For example, if the buffer depth increases by 10 samples over 208 seconds, it can be estimated that the clock offset estimate is still off by 1 ppm (residual clock offset). Thus, 1 ppm can be added or subtracted from a current clock offset estimate that is fed to the resampler. Furthermore the trajectory of the buffer depth may be analyzed. If it is linearly increasing or decreasing with little variance, confidence in its accurate reflection of the residual clock offset may be increased or decrease.

If the buffer depth becomes very large or very small, it may be necessary to other actions such as, for example, resetting the buffer to a nominal depth and take evasive measures in the echo canceller due to the resulting timing glitch.

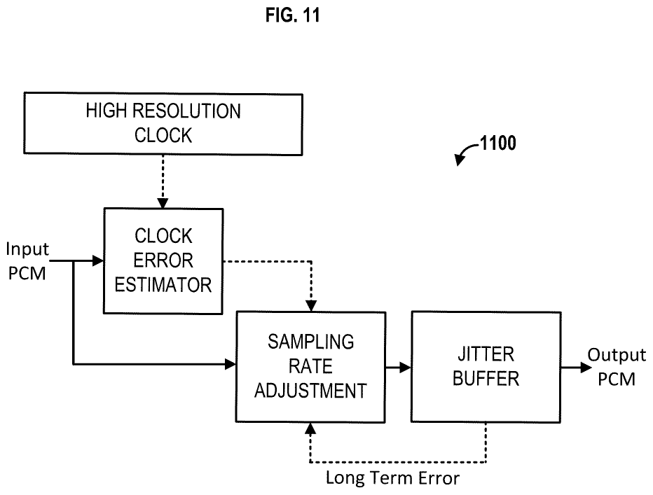

FIG. 11 shows an example system 1100 comprising the clock error estimator, the sampling rate adjuster, and the buffer. The system 1100 may be configured to detect long term slips by monitoring the peak echo canceller coefficient, whose position approximately represents the direct echo path between speaker and microphone. The peak will move as the clocks drift.

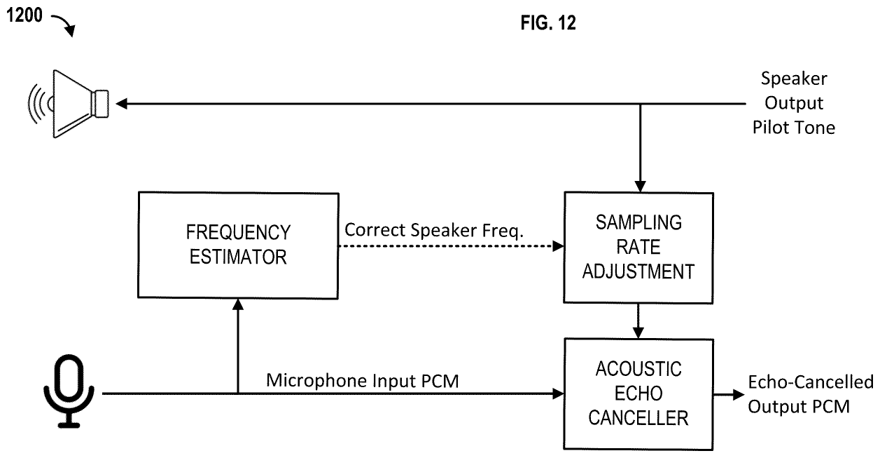

FIG. 12 shows an example system 1200. The example system 1200 may comprise a clock error compensation mechanism and an echo canceller. Clock error estimation and clock error compensation may be performed as described herein to enable the use of an acoustic echo canceller in a system that has a speaker sampling clock and a microphone sampling lock that are not derived from the same reference clock (and therefore may vary in sampling frequency and may not be phase locked). FIG. 12 depicts how the sampling rate adjustment and compensation fits into such a system using both types of frequency estimation techniques based upon the use of a pilot tone. The effective reference is the pilot tone that is played out by the speaker and received by the microphone. FIG. 12 shows a case where the resampling is done on the speaker output but the resampling can be done on the microphone input.

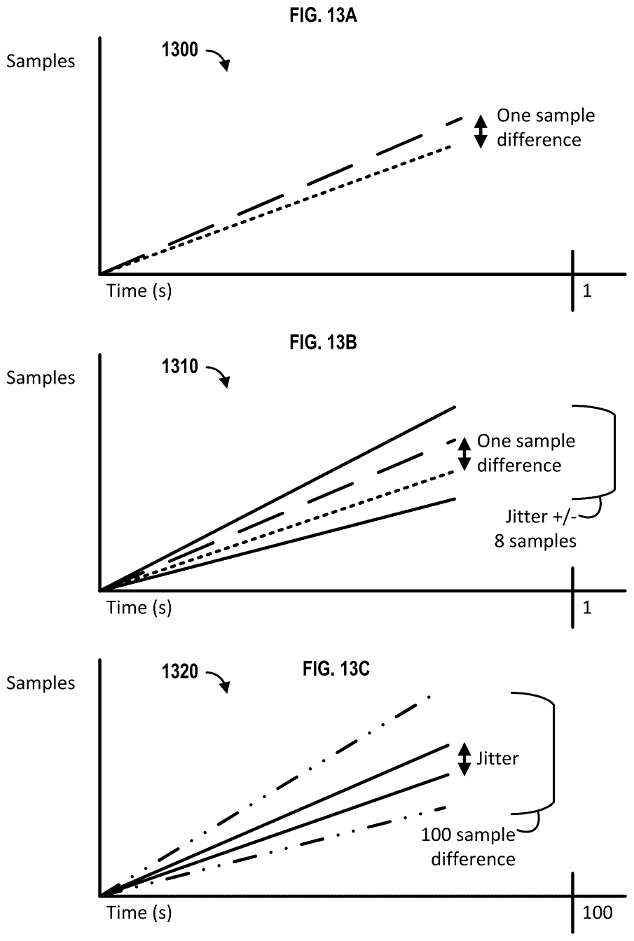

FIG. 13A shows a number of samples taken in a speaker and a microphone whose clocks are not locked. For the purpose of this discussion, both sampling rates are intended to be 16 kHz but the microphone clock is actually 16,001 Hz and the speaker clock is actually 16,000 Hz. The top line shows the number of samples that have accumulated between time 0 and 1 second for the microphone. The bottom line shows the same for the speaker. The difference in the slope of the two lines reflects the frequency difference between the two clocks. For example, the figure shows a 1 sample difference but it could be anywhere in the range of 0.5 to 1.5 due to the lack of precision due to the short duration. By measuring over a longer period of time, better precision may be achieved. For example, after 10 seconds, a difference of 10 samples+/−0.5 samples may be observed. The 0.5 sample error is divide by 10 seconds, improving the precision by a factor of 10.

FIG. 13B shows the effects of lack of clock synchronization in the presence of jitter (e.g., network jitter). Jitter is a variance in latency, or the time delay between when a signal is transmitted and when it is received. In the example in FIG. 13B, the jitter may be taken to be 1 millisecond, which corresponds to 16 samples at 16 kHz. Thus, the error estimate becomes 1 Hz+/−8 Hz. This is pictorially shown in the top and bottom lines where their respective slopes show the margin of error. In the below formulas, Fs=actual sampling rate, N=samples per packet, and Tp=time duration represented by one packet (e.g., N/Fs). Thus, if a receiver of the inbound audio packets counts NR the new number of samples received every Tp seconds, that number of samples will be 0, N, 2N. NR[m] may be defined as an array of samples received at packet period m. Thus, the measured sampling rate after M packet periods may be:

$$Measured Frequency = {\sum }_{m = 0}^{M} \frac{NR [ m ]}{Tp * M}$$

NR may be treated as a random variable with a mean of N. Thus:

$${lim}_{m \to ∞} \frac{1}{M} {\sum }_{m} NR [ m ] = N$$

Therefore, for a large number M of received packets:

$$Measured Frequency \approx \frac{N * M}{Tp * M} = \frac{N}{Tp} = Actual Sampling Rate$$

However, if M is not large enough, the error in measured frequency will be a function of the amount of (packet) jitter. If it is the case that the number of samples in a packet period cannot be counted with perfect timing precision, then:

$$Measured Frequency = {\sum }_{i = 0}^{M} \frac{NR [ i ]}{Tp * M}$$

In this case, Tp is no longer a constant. Therefore, it is no longer necessary to count packets/samples at equal intervals and the denominator (elapsed time) may have error. Thus, for sufficiently large M (number of packet periods), the measured frequency approaches and/or closely approximates the actual frequency.

However, for smaller M, the denominator error is a function of real time clock jitter where this jitter may be due to clock precision, jitter in reading real time clock due to preemption, etc. Therefore, error may be reduced by increasing the measurement duration. For example, if the measurement duration is increased to 100 seconds, the frequency difference estimate would be 1 Hz+/−8/100 Hz (as shown in FIG. 13C). Waiting 100 seconds though, may be impractical and users may still experience degraded echo cancellation. Thus, the present methods and systems may be configured to save the measured clock offset at the end of a session and begin the next session using that clock offset for the purpose of adjusting one of the clocks. This option makes the assumption that the clock error doesn't change much from session to session. While that may often be the case, crystal oscillators can drift as a function of temperature so it's possible that this method will not be foolproof.

The present methods and systems may be configured to make continuous measurements of the clock offset even when a session is not active, resulting in an accurate measure of the clock offset from the start of the call. The microphone(s) and speaker(s) may remain active even between sessions.

To estimate the sampling frequency error using packet timing, the below parameters may be implemented.
Parameters: NominalSpeakerSamplingRate
Initialization: Initialize SpeakerSampleCount, Set Start Time (using realtime clock or high resolution clock)
Runtime (During Analysis Window): Count number of received samples (NSamples)
At Any Point During Runtime:

$$MeasuredSamplingRate = NSamples / ( Current Time - Start Time )$$

$$PartsPerMillionClockError = ( MeasuredSamplingRate - NominalSamplingRate ) \text{} / NominalSamplingRate * 1 E 6.$$

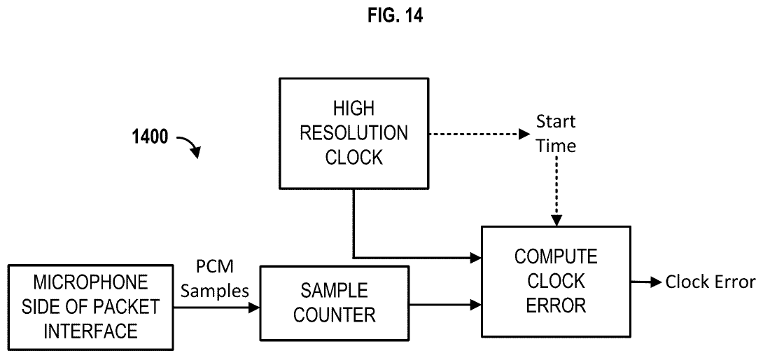

These parameters and associated algorithms may be implemented in the system shown in FIG. 14. The system 1400 of FIG. 14 may be configured to measure the variance of the sampling clock error and compare it to a threshold. Concretely, the error in parts per million could be computed at a smaller interval—perhaps 10 seconds. A measure of the mean and variance can be tracked. When the variance falls below a threshold, the sampling clock adjustment can be made. From that point forward, the adjustment could be made at the 10 second interval any time the variance falls below the minimum previous variance. The sampling clock may be adjusted, for example, according to the below:

### Parameters

NominalMicrophoneSamplingRate
SpeakerClockErrorPPM Initialization
Initialize Sampling Rate Converter

$$InputSamplingRate = NominalMicrophoneSamplingRate$$

$$OutputSamplingRate = InputSamplingRate$$

### Runtime

When each new microphone buffer is received, modify the sampling rate using the sampling rate converter.
At some interval (e.g., 15 minutes)
   Use the method to compute the speaker sampling frequency error described above.
   If adjusting the microphone sampling rate, the adjusted rate will be:

$$NominalSamplingRate * ( 1. + SpeakerClockErrorPPM / 1000000.0 f )$$

If adjusting the speaker sampling rate, the adjusted rate will be:

$$NominalSamplingRate * ( 1. - SpeakerClockErrorPPM / 1000000.0 f )$$

(Note the different sign in the equations. The signs are based upon the assumption that the real-time clock reference is that on the device with the microphone.) By making said request of the sampling rate converter as shown in FIG. 8.

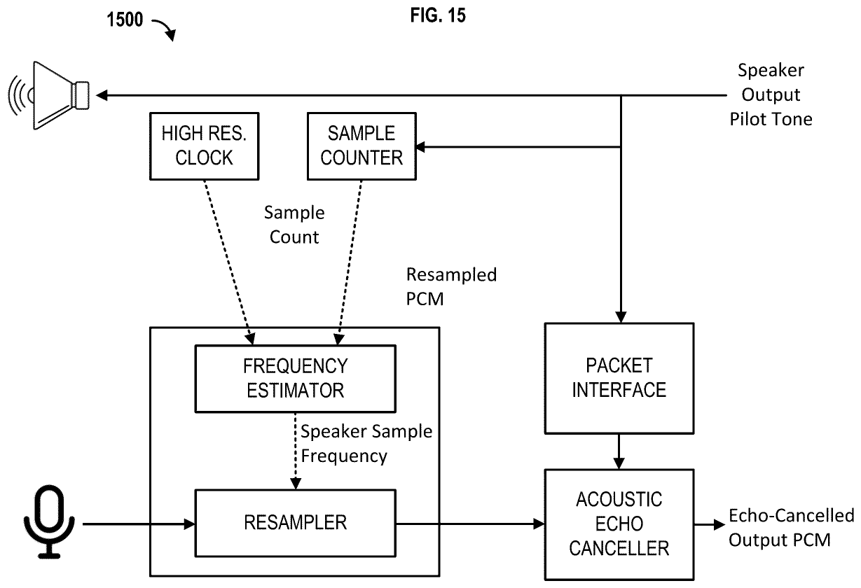

FIG. 15 shows an example system 1500. The system may comprise a speaker, a high resolution clock, a sample counter, a frequency estimator, a resampler, a microphone, a packet interface device (which may comprise a sending side interface, for example at the speaker device, and a receiving side interface, for example at the microphone device and/or echo canceller device), and an acoustic echo canceller. In the example system 1500, the present methods may adjust the microphone sampling clock so that it matches the speaker sampling clock. In the example system 1500, the high resolution clock and the microphone sampling clock may be derived from the same source clock. In the example system 1500, the speaker output signal feeds the sample counter which may be configured to count speaker samples. The clock offset estimator uses the sample count and high resolution clock to estimate the speaker sampling frequency. The speaker sampling frequency is fed to the resampler (which may be a software component), which resamples the microphone input PCM so that it matches the speaker sampling frequency. The speaker PCM and resampled microphone PCM feed the acoustic echo canceller, which removes echo from the speaker that may have fed back from the speaker to the microphone, producing the echo-cancelled output PCM.

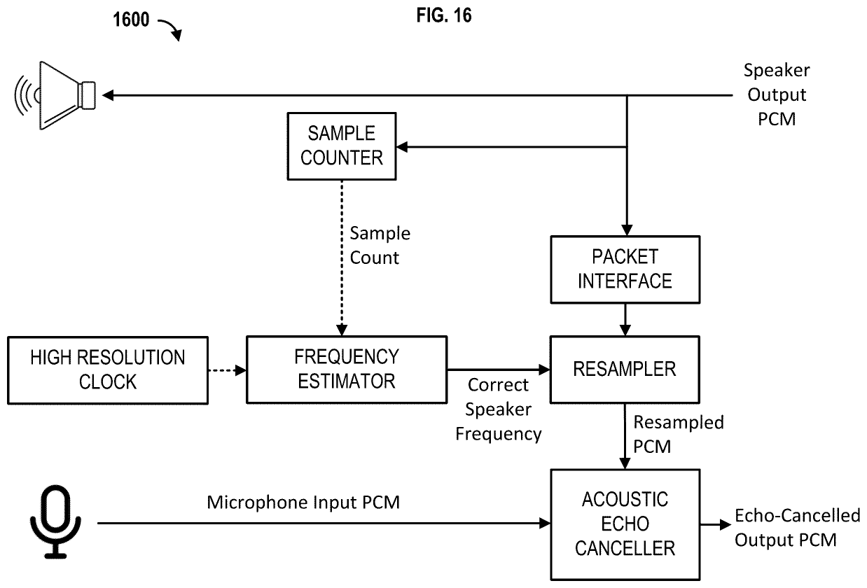

FIG. 16 shows an example system 1600. In the example system 1600, the adjustment can be done on the reference signal(s) rather than the microphone signal(s). In the example system 1600 the speaker sampling frequency estimation is done the same way is in the example system 1500, but the output of the frequency estimator may be different. For example, in the example system 1600, the frequency estimator outputs the sampling frequency to which that speaker PCM samples need to be resampled to match the microphone PCM sampling frequency. The speaker output PCM is resampled at that frequency and the resampled output along with the microphone input PCM are fed to the acoustic echo canceller, which cancels the echo.

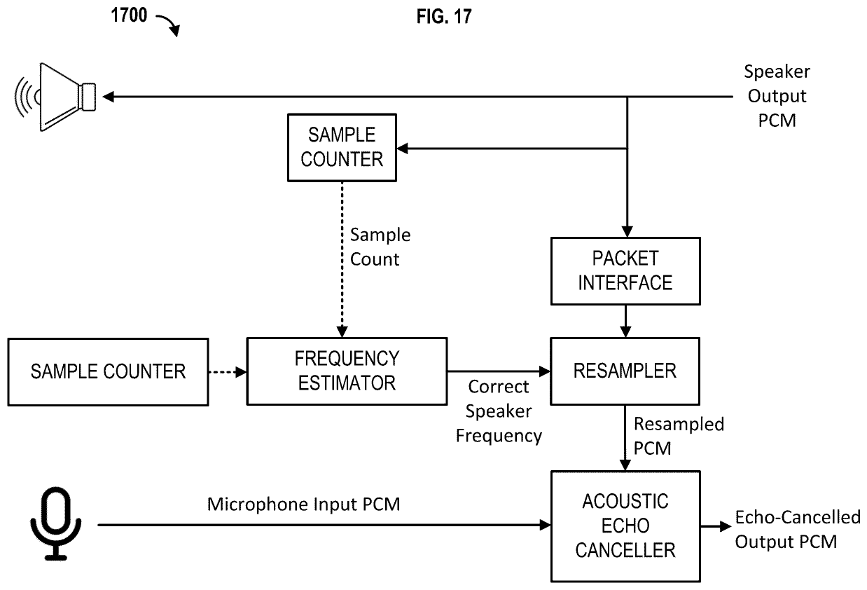

FIG. 17 shows an example system 1700. In the example system 1700, clock compensation may be performed when no real-time clock is available or when the real-time clock is not derived from the same master clock as the microphone clock. In the example system 1700, the real-time clock is replaced with a microphone sample counter.

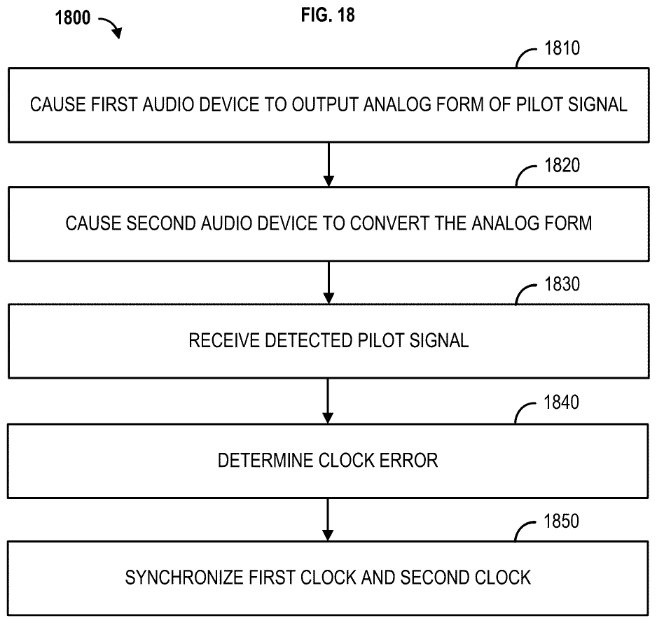

FIG. 18 is a flowchart of an example method 1800. The method may be carried out via any one or more devices described herein. At 1810 a first audio device may be caused to output an analog form of a pilot signal. The first audio device may comprise a speaker. The first audio device may be associated with a first clock. The first clock may be associated with a first sample rate. The pilot signal may be associated with a first frequency. The pilot signal comprises one or more of an audible frequency, or an inaudible frequency.

At 1820, a second audio device may be caused to convert the analog form of the pilot signal to a detected pilot signal. The detected pilot signal may comprise a digital signal. The second audio device may comprise a microphone. The second audio device may be associated with a second clock. The second audio device may be driven by the second clock. For example, a sampling rate of the second audio device may be driven by the second clock.

At 1830, the detected pilot signal may be received. The detected pilot signal may be received from the second audio device.

At 1840, a clock error may be determined. The clock error may be associated with the first clock. The clock error may be associated with the second clock. The clock error may indicate either or both of the first clock or the second clock has sped up or slowed down with respect to a reference clock. The clock error may be determined based on a digital form of the pilot signal and the detected pilot signal. The clock error may be determined based on a zero-crossing method. The clock error may be determined based on a phrase trajectory offset method.

At 1850, the first clock and the second clock may be synchronized. Synchronizing the first clock and the second clock may comprise adjusting (e.g., updating, resetting) one or more samples rates.

The method may comprise determining a phase shift between the digital form of the pilot signal and the detected pilot signal.

The method may comprise causing a first audio device to output an analog form of a pilot signal at a first frequency. The method may comprise receiving, from a second audio device, a digital form of the pilot signal, wherein the digital form of the pilot signal comprises a second frequency associated with a sampling rate. The method may comprise determining a difference between the first frequency and the second frequency. The method may comprise determining, based on the difference between the first frequency and the second frequency, a clock error. The method may comprise adjusting, based on the clock error, the sampling rate.

The method may comprise causing a first audio device to output an analog form of a pilot signal at a first frequency. The method may comprise receiving, from a second audio device, a digital form of the pilot signal, wherein the digital form of the pilot signal comprises a second frequency associated with a sampling rate. The method may comprise determining, based on a difference between the first frequency and the second frequency, a clock error. The method may comprise receiving, from the second audio device, one or more samples of audio output by the first audio device. The method may comprise buffering, based on the clock error, the one or more samples of audio. When a signal is resampled, N samples may be input at a time into the resampler. If the resampler's output sampling rate equals its input sampling rate, the number of output samples per N input samples is N. If the output sampling rate is higher than the input sampling rate, output may contain, for example, N+1 samples but most of the time it will include N samples. If the output sampling rate is lower than the input sampling rate, the output may comprise, for example, N−1 samples. Thus, the echo canceller may implement buffering. For example, the echo canceller may query the buffer to see how many samples are available before doing any processing.

For example, if the speaker path processes N samples at a time and the microphone path does the same, due to clock error the accumulation of N samples will take a slightly different amount of time for the speaker path and the microphone path. When the microphone path has N samples, it's possible that the speaker's resampler output buffer will be one sample short or have one extra sample.

One of the goals of resampling is to ensure a 1:1 relationship between the number of resampled speaker samples and microphone samples. That's what happens when we have achieved a perfect estimate of the clock difference.

But if a perfect estimate has not yet been achieved, the resampler's output buffer will either grow slowly or shrink slowly. The rate of growth or shrinkage (in samples per second) is another indication that the resampler hasn't reached its target yet. Thus, the growth or shrinkage rate may be used to further adjust the clock offset estimate until it reaches equilibrium on its own.

The method may comprise receiving, by an intermediary device, from a first audio device associated with a first clock, within a period of time, a quantity of samples of first audio data. The method may comprise receiving, by the intermediary device, from a second audio device associated with a second clock, within the period of time, a quantity of samples of second audio data. The method may comprise comparing the quantity of samples of first audio data to the quantity of samples of second audio data. The method may comprise determining, based on the comparison of the quantity of samples of first audio data to the quantity of samples of second audio data, a difference in the quantity of samples of first audio data and the quantity of samples of second audio data. The method may comprise determining, based on the difference in the quantity of samples of first audio data and the quantity of samples of second audio data, a clock error associated with at least one of the first clock or the second clock.

The method may comprise receiving, by a device, one or more samples of audio data. The method may comprise storing a quantity of samples of audio data of the one or more samples of audio data. The method may comprise determining the quantity of samples of audio data satisfies a threshold. The method may comprise based on determining the quantity of samples of audio data satisfies a threshold, sending the quantity of samples of audio data to an echo cancellation device.

The method may comprise storing, by a storage device, a quantity of samples of first audio data. The method may comprise receiving, from a device, a quantity of samples of second audio data. The method may comprise storing the quantity of samples of first audio. The method may comprise determining the stored quantity of silence samples and the stored quantity of samples of first audio satisfies a threshold. The method may comprise determining, based on the stored quantity of samples of first audio data and second audio data satisfying the threshold, a clock error associated with the device.

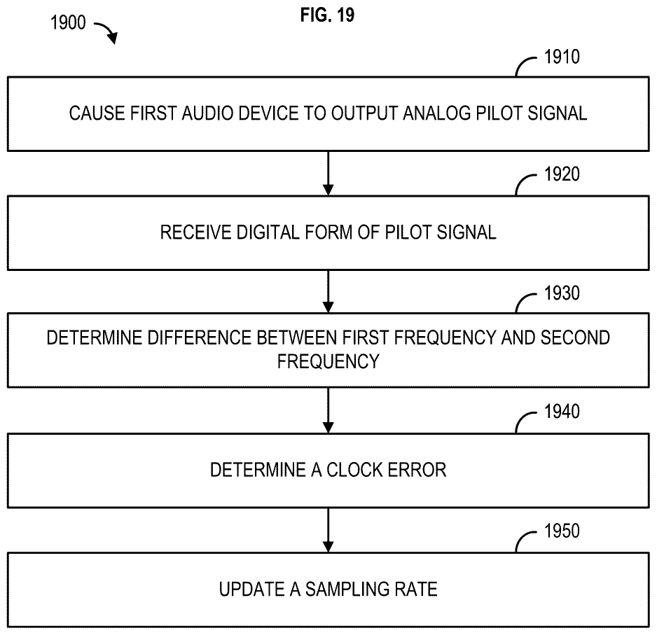

FIG. 19 is a flowchart of an example method 1900. The method may be carried out on any one or more devices as described herein. At 1910, a first audio device may be caused to output an analog form of a pilot signal. The first audio device may be caused to output the analog form of the pilot signal at a first frequency. The first audio device may comprise a speaker. The pilot signal may comprise one or more of: an audible signal or an inaudible signal. The first audio device may be associated with a first clock (e.g., a speaker clock).

At 1920, a digital form of the pilot signal may be received. The digital form of the pilot signal may be received from a second audio device. The second audio device may comprise a microphone. The second audio device may be associated with a second clock (e.g., a microphone clock). The digital form of the pilot signal may comprise a second frequency. The second frequency may be associated with a sampling rate.

At 1930, a difference between the first frequency and the second frequency may be determined. Determining the difference between the first frequency and the second frequency may comprise determining the first frequency is greater than the second frequency. Determining the difference between the first frequency and the second frequency may comprise determining the second frequency is greater than the first frequency.

At 1940, a clock error may be determined. The clock error may be determined based on the difference between the first frequency and the second frequency. Determining the clock error may be based on a zero-crossing method. Determining the clock error may be determined based on a phase trajectory offset method.

At 1950, a sampling rate may be updated. The sampling rate may be associated with the first clock. The sampling rate may be associated with the second clock.

The method may comprise synchronizing the first clock and second clock. The method may comprise performing echo cancellation. Echo cancellation may be performed based on the updated sampling rate.

The method may comprise causing a first audio device to output an analog form of a pilot signal, wherein the first audio device is associated with a first clock. The method may comprise causing a second audio device to convert the analog form of the pilot signal to a detected pilot signal, wherein the second audio device is associated with a second clock. The method may comprise receiving, from the second audio device, the detected pilot signal. The method may comprise determining, based on a digital form of the pilot signal and the detected pilot signal, a clock error. The method may comprise synchronizing, based on the clock error, the first clock and the second clock.

The method may comprise causing a first audio device to output an analog form of a pilot signal at a first frequency. The method may comprise receiving, from a second audio device, a digital form of the pilot signal, wherein the digital form of the pilot signal comprises a second frequency associated with a sampling rate. The method may comprise determining, based on a difference between the first frequency and the second frequency, a clock error. The method may comprise receiving, from the second audio device, one or more samples of audio output by the first audio device. The method may comprise buffering, based on the clock error, the one or more samples of audio.

The method may comprise receiving, by an intermediary device, from a first audio device associated with a first clock, within a period of time, a quantity of samples of first audio data. The method may comprise receiving, by the intermediary device, from a second audio device associated with a second clock, within the period of time, a quantity of samples of second audio data. The method may comprise comparing the quantity of samples of first audio data to the quantity of samples of second audio data. The method may comprise determining, based on the comparison of the quantity of samples of first audio data to the quantity of samples of second audio data, a difference in the quantity of samples of first audio data and the quantity of samples of second audio data. The method may comprise determining, based on the difference in the quantity of samples of first audio data and the quantity of samples of second audio data, a clock error associated with at least one of the first clock or the second clock.

The method may comprise receiving, by a device, one or more samples of audio data. The method may comprise storing a quantity of samples of audio data of the one or more samples of audio data. The method may comprise determining the quantity of samples of audio data satisfies a threshold. The method may comprise based on determining the quantity of samples of audio data satisfies a threshold, sending the quantity of samples of audio data to an echo cancellation device.

The method may comprise storing, by a storage device, a quantity of samples of first audio data. The method may comprise receiving, from a device, a quantity of samples of second audio data. The method may comprise storing the quantity of samples of first audio. The method may comprise determining the stored quantity of silence samples and the stored quantity of samples of first audio satisfies a threshold. The method may comprise determining, based on the stored quantity of samples of first audio data and second audio data satisfying the threshold, a clock error associated with the device.

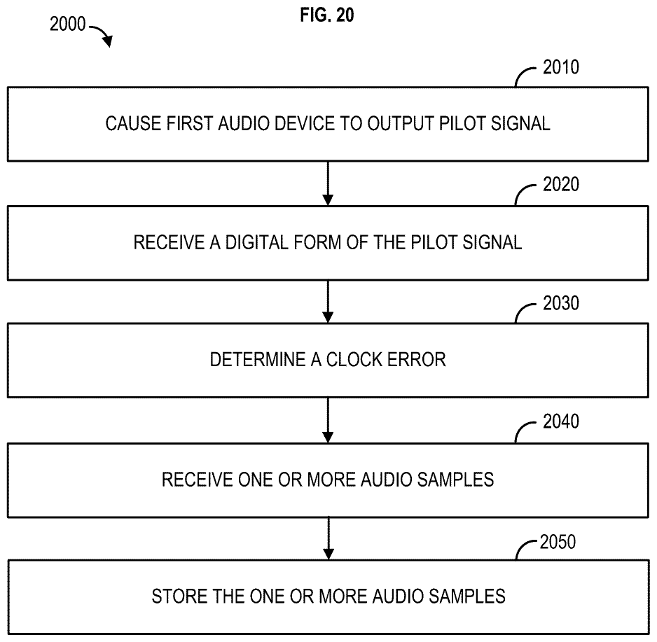

FIG. 20 is a flowchart of an example method 2000. The method may be carried out on any one or more devices as described herein. At 2010, a first audio device may be caused to output an analog form of a pilot signal. The first audio device may comprise a speaker. The first audio device may be associated with a first clock. The first audio device may output the analog form of the pilot signal at a first frequency. The pilot signal may comprise one or more of: an audible frequency or an inaudible frequency.

At 2020, a digital form of the pilot signal may be received. The digital form of the pilot signal may be received from a second audio device. The second audio device may comprise a microphone. The second audio device may be associated with a second clock. The digital form of the pilot signal may comprise a second frequency. The second frequency may be associated with a sampling rate. There may be a difference between the first frequency and the second frequency.

At 2030, a clock error may be determined. The clock may be determined based on the difference between the first frequency and the second frequency. For example, the first frequency may be an expected frequency and the second frequency may be a detected frequency.

At 2040, one or more samples of audio may be received from the second audio device. The one or more samples of audio may comprise audio sampled from the pilot signal output by the first device.

At 2050, the one or more samples of audio may be buffered. Buffering the one or more samples of audio may comprise temporarily storing the one more samples of audio. The one or more samples of audio may be buffered based on the clock error. For example, the one or more samples of audio may be buffered based on detecting the clock error. For example, the one or more samples of audio may be buffered for a length of time associated with the clock error. The clock error may be associated with the first clock, the second clock, or both clocks. Determining the clock error may comprise determining a zero-crossing frequency. Determining the clock error may comprise determining one or more phase trajectories.

The method may comprise performing, based on the clock error, echo cancellation. The method may comprise causing a first audio device to output an analog form of a pilot signal, wherein the first audio device is associated with a first clock. The method may comprise causing a second audio device to convert the analog form of the pilot signal to a detected pilot signal, wherein the second audio device is associated with a second clock. The method may comprise receiving, from the second audio device, the detected pilot signal. The method may comprise determining, based on a digital form of the pilot signal and the detected pilot signal, a clock error. The method may comprise synchronizing, based on the clock error, the first clock and the second clock.

The method may comprise causing a first audio device to output an analog form of a pilot signal at a first frequency. The method may comprise receiving, from a second audio device, a digital form of the pilot signal, wherein the digital form of the pilot signal comprises a second frequency associated with a sampling rate. The method may comprise determining a difference between the first frequency and the second frequency. The method may comprise determining, based on the difference between the first frequency and the second frequency, a clock error. The method may comprise adjusting, based on the clock error, the sampling rate.

The method may comprise receiving, by an intermediary device, from a first audio device associated with a first clock, within a period of time, a quantity of samples of first audio data. The method may comprise receiving, by the intermediary device, from a second audio device associated with a second clock, within the period of time, a quantity of samples of second audio data. The method may comprise comparing the quantity of samples of first audio data to the quantity of samples of second audio data. The method may comprise determining, based on the comparison of the quantity of samples of first audio data to the quantity of samples of second audio data, a difference in the quantity of samples of first audio data and the quantity of samples of second audio data. The method may comprise determining, based on the difference in the quantity of samples of first audio data and the quantity of samples of second audio data, a clock error associated with at least one of the first clock or the second clock.

The method may comprise receiving, by a device, one or more samples of audio data. The method may comprise storing a quantity of samples of audio data of the one or more samples of audio data. The method may comprise determining the quantity of samples of audio data satisfies a threshold. The method may comprise based on determining the quantity of samples of audio data satisfies a threshold, sending the quantity of samples of audio data to an echo cancellation device.

The method may comprise storing, by a storage device, a quantity of samples of first audio data. The method may comprise receiving, from a device, a quantity of samples of second audio data. The method may comprise storing the quantity of samples of first audio. The method may comprise determining the stored quantity of silence samples and the stored quantity of samples of first audio satisfies a threshold. The method may comprise determining, based on the stored quantity of samples of first audio data and second audio data satisfying the threshold, a clock error associated with the device.

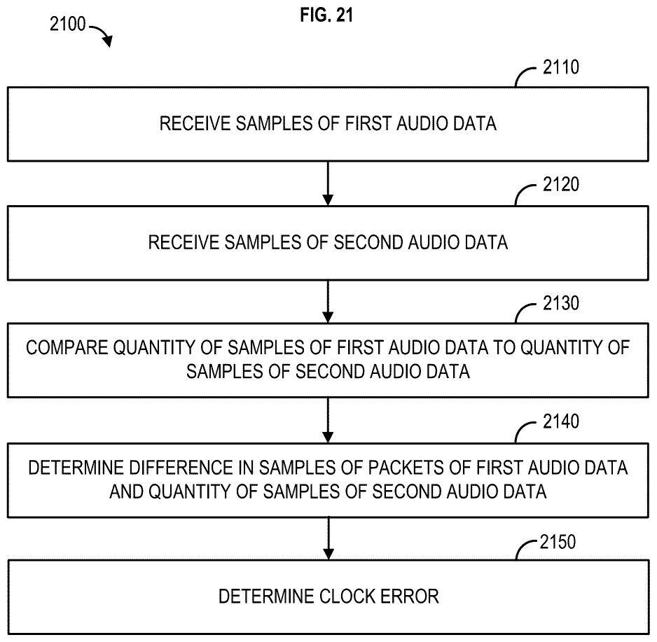

FIG. 21 shows an example method 2100. The example method 2100 may be carried out via any one or more devices described herein. At 2110, a quantity of samples of first audio data may be received. For example, the quantity of samples of first audio data may be received by an intermediary device. For example, the intermediary device may comprise an echo canceller. For example, the echo canceller may reside at a second audio device or at another device. For example, the second audio device may comprise a microphone device. The quantity of samples of first audio data may be received, for example, from a first audio device. For example, the first audio device may comprise a speaker device. Additionally and/or alternatively, the quantity of samples of first audio data may be received by a third device. For example, the third device may comprise a packet interface device. For example, the packet interface device may reside at the speaker device. For example, the packet interface device may reside, in the systems described herein, between the first audio device (the speaker device) and the second audio device (the microphone device). The packet interface device may be configured to receive digital audio data bound for the first audio device. The quantity of samples of first audio data may comprise audio data configured to be received by the first audio device. For example, the quantity of samples of first audio data may comprise digital audio data configured to be converted, by the first audio device, to one or more analog signals configured to be output by the first audio device. Each packet of the quantity of samples of first audio data may comprise a given amount of data (e.g., a given number of samples, a given time's worth of data). For example, each packet of the quantity of samples of first audio data may comprise one milliseconds worth of audio data configured to be output by the first audio device. For example, each packet may comprise 16 samples. Thus, the aforementioned example would indicate the first audio device is configured to be driven at a sampling rate of 16 kHz. For example, the first audio device may be driven by a first clock. The first clock may be configured to drive the first audio device at a first sampling rate. The quantity of samples of first audio data may be received with a period of time (e.g., one millisecond, one second, one minute, one hour, etc. . . . ).

At 2120, a quantity of samples of second audio data may be received. The quantity of samples of second audio data may be received, for example, by the intermediary device. The quantity of samples of second audio data may comprise one or more samples of digital audio data determined by the second audio device. The second audio device may, for example, detect one or more received analog signals in an environment, convert the one or more received analog signals to one or more digital signals, and packetize the one or more digital signals. The second audio device may be driven by a second clock. The second clock may be configured to drive the second audio device at a second sampling rate. The first sampling rate and second sampling rate may, in the absence of clock error, be the same sampling rate. However, when either of the first clock or second clock is subject to clock error, the first sampling rate and the second sampling rate may be different.

At 2130, the quantity of samples of first audio data and the quantity of samples of second audio data may be compared. For example, an amount of data in the quantity of samples of first audio data and an amount of data in the quantity of samples of second audio data may be compared. For example, a number of samples in the quantity of samples of first audio data and a number of samples in the quantity of samples of second audio data may be compared.

At 2140, a difference in the quantity of samples of first audio data and the quantity of samples of second audio data may be determined. For example, the difference may comprise a difference in a number of samples received from the first audio device (and/or the packet interface device) and a number of samples received from the second audio device. For example, the difference may comprise a difference in a number of samples received from the first audio device (and/or the packet interface device) and a number of samples received from the second audio device. For example, the difference may comprise a difference in an amount of data received from the first audio device (and/or the packet interface device) and an amount of data received from the second audio device. For example, if every samples contains 1 millisecond worth of data, so, at 16 kHz sampling rate, 1 millisecond worth of data would contain 16 samples. So, if the first clock (e.g., the clock driving the speaker device) is drifting faster (e.g., it may be causing the speaker to sample at 16,001 Hz), whereas the second clock (e.g., the clock driving microphone) is sampling at 16 kHz, over a given time, the intermediary device may receive, from the first audio device (and/or the packet interface device) one or more extra samples (e.g., one or more samples more than would be received if the first clock were not drifting and was driving the first audio device at 16 kHz). In the preceding example, the intermediary device may receive one “extra” packet of first audio data from the first audio device (and/or the packet interface device) every 16 seconds. The aforementioned example is merely exemplary and explanatory and is not meant to be limiting.

Optionally, the first audio device (and/or the packet interface device) may comprise a buffer. The buffer may be configured to store one or more samples bound for the first audio device and packetize the one or more samples. For example, the buffer may be configured to store 16 samples and packetize the 16 samples into a packet. The buffer may be configured to receive the one or more samples until a threshold number of samples of received/stored, and send, to the intermediary device, a packet comprised of the 16 samples.

For example, determining the difference may comprise determining the quantity of samples of first audio data is greater than the quantity of samples of second audio data. For example, determining the difference may comprise determining the quantity of samples of first audio data is less than the quantity of samples of second audio data.

The method may comprise determining a cumulative number of samples (or amount of data or amount of samples) received from the first audio device and the second audio device and/or stored (at any given time) by an intermediary device (e.g., a buffer). The method may comprise determining a cumulative amount of data received from the first audio device and the second audio device. The method may comprise determining a cumulative number of samples (or amount of data or amount of samples) that includes the quantity samples received from the first audio device, the quantity of samples received from the second audio device, and a quantity of samples stored in the intermediary device before or during receipt of the quantity of samples from the first audio device and the quantity of samples received from the second audio device. One of the reasons for the buffering is that the echo canceller should operate on an equal number of speaker and microphone samples at a time. Thus, if the buffer accumulates N samples of microphone data, N samples from the speaker should be read out of the buffer. Because the buffer is filled to a nominal level with zero-amplitude samples, the expectation is that there will always be at least N samples in the speaker buffer to be read. Thus, if the sampling rate is error free, the buffer will never overflow or underflow.

At 2150, a clock error associated with at least one of the first clock or the second clock may be determined. For example, the clock error associated with at least one of the first clock or the second clock may be determined based on the difference in the quantity of samples of first data and the quantity of samples of second audio data. For example, the clock error associated with at least one of the first clock or the second clock may be determined based on the cumulative number of samples.

The method may comprise causing, based on the clock error associated with at least one of the first clock or the second clock, a resampling of at least one of the first clock or the second clock.

The method may comprise causing a first audio device to output an analog form of a pilot signal, wherein the first audio device is associated with a first clock. The method may comprise causing a second audio device to convert the analog form of the pilot signal to a detected pilot signal, wherein the second audio device is associated with a second clock. The method may comprise receiving, from the second audio device, the detected pilot signal. The method may comprise determining, based on a digital form of the pilot signal and the detected pilot signal, a clock error. The method may comprise synchronizing, based on the clock error, the first clock and the second clock.

The method may comprise causing a first audio device to output an analog form of a pilot signal at a first frequency. The method may comprise receiving, from a second audio device, a digital form of the pilot signal, wherein the digital form of the pilot signal comprises a second frequency associated with a sampling rate. The method may comprise determining a difference between the first frequency and the second frequency. The method may comprise determining, based on the difference between the first frequency and the second frequency, a clock error. The method may comprise adjusting, based on the clock error, the sampling rate.

The method may comprise causing a first audio device to output an analog form of a pilot signal at a first frequency. The method may comprise receiving, from a second audio device, a digital form of the pilot signal, wherein the digital form of the pilot signal comprises a second frequency associated with a sampling rate. The method may comprise determining, based on a difference between the first frequency and the second frequency, a clock error. The method may comprise receiving, from the second audio device, one or more samples of audio output by the first audio device. The method may comprise buffering, based on the clock error, the one or more samples of audio.

The method may comprise receiving, by a device, one or more samples of audio data. The method may comprise storing a quantity of samples of audio data of the one or more samples of audio data. The method may comprise determining the quantity of samples of audio data satisfies a threshold. The method may comprise based on determining the quantity of samples of audio data satisfies a threshold, sending the quantity of samples of audio data to an echo cancellation device.

The method may comprise storing, by a storage device, a quantity of samples of first audio data. The method may comprise receiving, from a device, a quantity of samples of second audio data. The method may comprise storing the quantity of samples of first audio. The method may comprise determining the stored quantity of silence samples and the stored quantity of samples of first audio satisfies a threshold. The method may comprise determining, based on the stored quantity of samples of first audio data and second audio data satisfying the threshold, a clock error associated with the device.

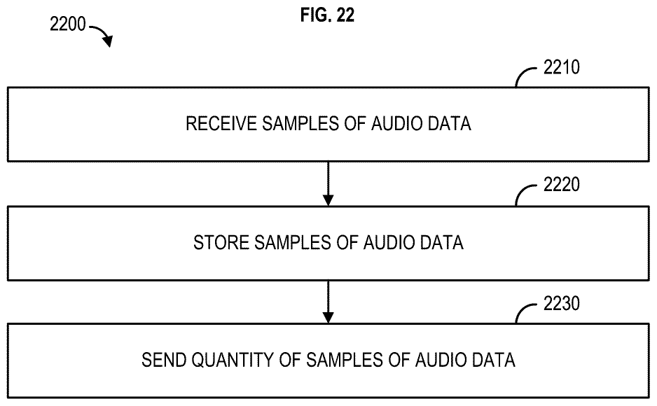

FIG. 22 shows an example method 2200. The example method 2200 may be carried out via any one or more devices described herein. At 2210, a device may receive one or more samples of audio data. For example, the device may comprise a packet interface device. For example, the one or more samples of audio data may be configured to be output at (e.g., output by, output via) a speaker device.

At 2220, the device may store the one or more samples of audio data. For example, the device may store a quantity of samples of the one or more samples of audio data.

Optionally, it may be determined that the quantity of samples of audio data satisfies a threshold. For example, the device may be configured to determine the quantity of samples of audio data satisfies the threshold. The threshold may be associated with a number (e.g., a number of samples), an amount of data, a period of time, combinations thereof, and the like. For example, the threshold may be 16 samples of data. For example, the period of time may be 1 millisecond. The aforementioned examples are merely exemplary and explanatory and are not intended to be limiting.

At 2230, the quantity of samples may be sent. For example, the quantity of samples may be sent to an echo canceller. For example, the quantity of samples may be sent to a buffer. For example, the quantity of samples may be sent based on determining the quantity of samples satisfies the threshold.

The method may comprise making one or more copies of the one or more samples of audio data. The method may comprise sending the one or more copies of the samples of audio data.

The method may comprise causing a first audio device to output an analog form of a pilot signal, wherein the first audio device is associated with a first clock. The method may comprise causing a second audio device to convert the analog form of the pilot signal to a detected pilot signal, wherein the second audio device is associated with a second clock. The method may comprise receiving, from the second audio device, the detected pilot signal. The method may comprise determining, based on a digital form of the pilot signal and the detected pilot signal, a clock error. The method may comprise synchronizing, based on the clock error, the first clock and the second clock.

The method may comprise causing a first audio device to output an analog form of a pilot signal at a first frequency. The method may comprise receiving, from a second audio device, a digital form of the pilot signal, wherein the digital form of the pilot signal comprises a second frequency associated with a sampling rate. The method may comprise determining a difference between the first frequency and the second frequency. The method may comprise determining, based on the difference between the first frequency and the second frequency, a clock error. The method may comprise updating, based on the clock error, the sampling rate.

The method may comprise causing a first audio device to output an analog form of a pilot signal at a first frequency. The method may comprise receiving, from a second audio device, a digital form of the pilot signal, wherein the digital form of the pilot signal comprises a second frequency associated with a sampling rate. The method may comprise determining, based on a difference between the first frequency and the second frequency, a clock error. The method may comprise receiving, from the second audio device, one or more samples of audio output by the first audio device. The method may comprise buffering, based on the clock error, the one or more samples of audio.

The method may comprise receiving, by an intermediary device, from a first audio device associated with a first clock, within a period of time, a quantity of samples of first audio data. The method may comprise receiving, by the intermediary device, from a second audio device associated with a second clock, within the period of time, a quantity of samples of second audio data. The method may comprise comparing the quantity of samples of first audio data to the quantity of samples of second audio data. The method may comprise determining, based on the comparison of the quantity of samples of first audio data to the quantity of samples of second audio data, a difference in the quantity of samples of first audio data and the quantity of samples of second audio data. The method may comprise determining, based on the difference in the quantity of samples of first audio data and the quantity of samples of second audio data, a clock error associated with at least one of the first clock or the second clock.

The method may comprise storing, by a storage device, a quantity of samples of first audio data. The method may comprise receiving, from a device, a quantity of samples of second audio data. The method may comprise storing the quantity of samples of second audio data. The method may comprise determining the stored quantity of samples of first audio data and the stored quantity of samples of first audio satisfies a threshold. The method may comprise determining, based on the stored quantity of samples of first audio data and second audio data satisfying the threshold, a clock error associated with the device.

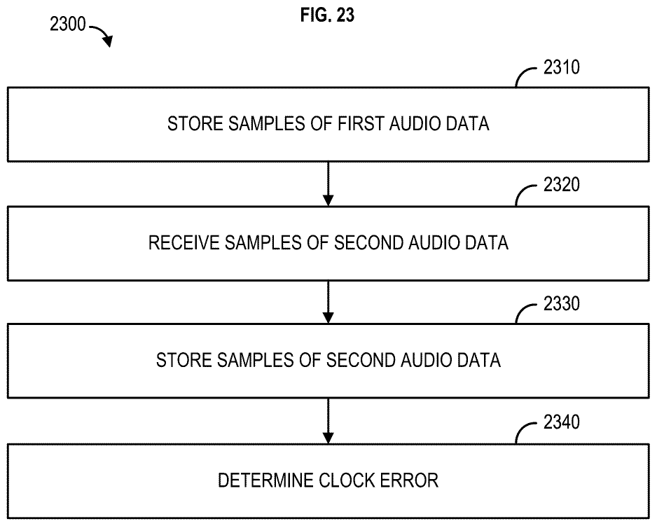

FIG. 23 shows an example method 2300. The example method 2300 may be carried out via any one or more devices described herein. At 2310, a quantity of samples of first audio data may be stored. For example, the quantity of samples of first audio data may be stored by a storage device. For example, the storage device may comprise a buffer. For example, the storage device may be associated with an echo canceller device. For example, the quantity of samples of first audio data may comprise one or more silence samples. The one or more silence samples may comprise zero-amplitude audio data (e.g., zero amplitude audio samples).

At 2320, a quantity of samples of second audio data may be received. For example, the quantity of samples of second audio data may comprise one or more samples of audio data configured for output by a speaker device. For example, the quantity of samples of second audio data may be received from a packet interface device. For example, the quantity of samples of second audio data may be received from a speaker device. For example, the quantity of samples of second audio data may comprise audio-data having non-zero amplitude audio data.

At 2330, the quantity of samples of second audio data may be stored.

Optionally, it may be determined that the stored quantity of samples of first audio data and the quantity of samples of second audio data satisfies a threshold. For example, the threshold may be a number of samples. For example, the threshold may be an amount of data. For example, the threshold may be a high threshold (e.g., a high water mark). For example, the threshold may be a low threshold (e.g., a low water mark).

At 2340, a clock error may be determined. For example, the clock may be determined based on the quantity of samples of first audio data and the quantity of samples of second audio satisfying a threshold. For example, the storage device may be configured to store a nominal quantity of samples of first audio data. For example, the storage device may be configured to send (e.g., read out) one or more samples of the quantity of samples of second audio data. For example, the storage device may be configured to send the one or more samples of the quantity of samples of second audio data to an echo canceller device. For example, the storage device may be configured to send the one or more samples of second audio data of the quantity of samples of second audio data at a given rate (e.g., a given frequency). For example, the storage device may be configured to send 16 samples of data every second. However, if the storage device is receiving samples faster than it is sending samples (e.g., it is receiving 17 samples every second), the quantity of samples stored will rise and eventually reach the threshold. Thus, it may be determined the device sending the samples to the storage device is being driven by a clock that experiencing positive drift. Similarly, if the storage device is receiving 15 samples every second, eventually, the quantity of samples stored in the storage device will fall to a low threshold, and it may be determined that the clock driving the device sending the samples to the storage device is experiencing negative clock error.

The method may comprise causing a first audio device to output an analog form of a pilot signal, wherein the first audio device is associated with a first clock. The method may comprise causing a second audio device to convert the analog form of the pilot signal to a detected pilot signal, wherein the second audio device is associated with a second clock. The method may comprise receiving, from the second audio device, the detected pilot signal. The method may comprise determining, based on a digital form of the pilot signal and the detected pilot signal, a clock error. The method may comprise synchronizing, based on the clock error, the first clock and the second clock.

The method may comprise causing a first audio device to output an analog form of a pilot signal at a first frequency. The method may comprise receiving, from a second audio device, a digital form of the pilot signal, wherein the digital form of the pilot signal comprises a second frequency associated with a sampling rate. The method may comprise determining a difference between the first frequency and the second frequency. The method may comprise determining, based on the difference between the first frequency and the second frequency, a clock error. The method may comprise updating, based on the clock error, the sampling rate.

The method may comprise causing a first audio device to output an analog form of a pilot signal at a first frequency. The method may comprise receiving, from a second audio device, a digital form of the pilot signal, wherein the digital form of the pilot signal comprises a second frequency associated with a sampling rate. The method may comprise determining, based on a difference between the first frequency and the second frequency, a clock error. The method may comprise receiving, from the second audio device, one or more samples of audio output by the first audio device. The method may comprise buffering, based on the clock error, the one or more samples of audio.

The method may comprise receiving, by an intermediary device, from a first audio device associated with a first clock, within a period of time, a quantity of samples (and/or samples) of first audio data. The method may comprise receiving, by the intermediary device, from a second audio device associated with a second clock, within the period of time, a quantity of samples of second audio data. The method may comprise comparing the quantity of samples of first audio data to the quantity of samples of second audio data. The method may comprise determining, based on the comparison of the quantity of samples of first audio data to the quantity of samples of second audio data, a difference in the quantity of samples of first audio data and the quantity of samples of second audio data. The method may comprise determining, based on the difference in the quantity of samples of first audio data and the quantity of samples of second audio data, a clock error associated with at least one of the first clock or the second clock.

The method may comprise receiving, by a device, one or more samples of audio data. The method may comprise storing a quantity of samples of audio data of the one or more samples of audio data. The method may comprise determining the quantity of samples of audio data satisfies a threshold. The method may comprise based on determining the quantity of samples of audio data satisfies a threshold, sending the quantity of samples of audio data to an echo cancellation device.

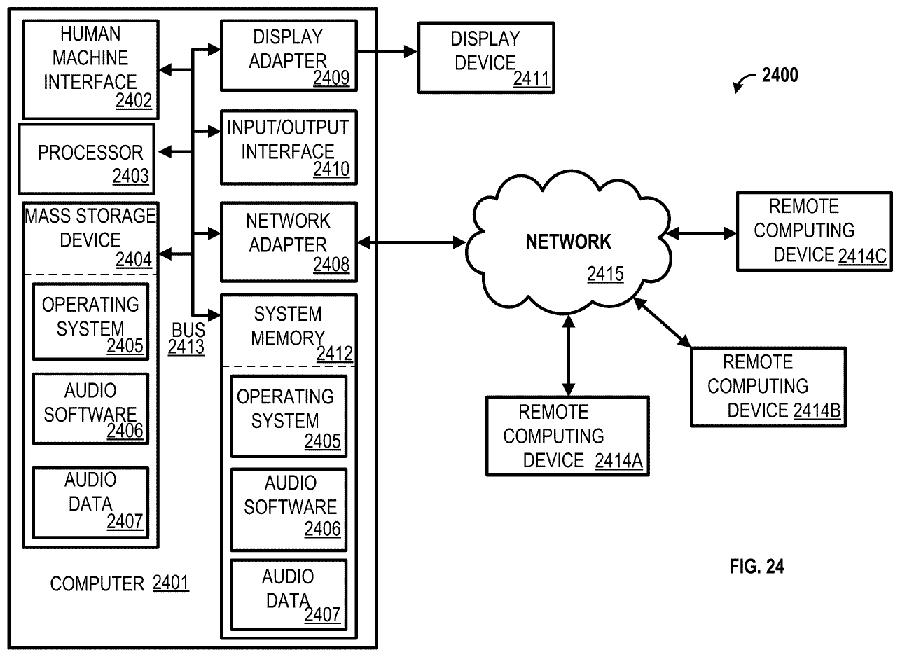

FIG. 24 shows a system 2400 for audio processing. Any device and/or component described herein may be a computer 2401 as shown in FIG. 24. The computer 2401 may comprise one or more processors 2403, a system memory 2412, and a bus 2413 that couples various components of the computer 2401 including the one or more processors 2403 to the system memory 2412. In the case of multiple processors 2403, the computer 2401 may utilize parallel computing.

The bus 2413 may comprise one or more of several possible types of bus structures, such as a memory bus, memory controller, a peripheral bus, an accelerated graphics port, and a processor or local bus using any of a variety of bus architectures.

The computer 2401 may operate on and/or comprise a variety of computer-readable media (e.g., non-transitory). Computer-readable media may be any available media that is accessible by the computer 2401 and comprises, non-transitory, volatile, and/or non-volatile media, removable and non-removable media. The system memory 2412 has computer-readable media in the form of volatile memory, such as random access memory (RAM), and/or non-volatile memory, such as read-only memory (ROM). The system memory 2412 may store data such as utterance data 2407 and/or program components such as operating system 2405 and utterance software 2406 that are accessible to and/or are operated on by the one or more processors 2403.

The computer 2401 may also comprise other removable/non-removable, volatile/non-volatile computer storage media. The mass storage device 2404 may provide non-volatile storage of computer code, computer-readable instructions, data structures, program components, and other data for the computer 2401. The mass storage device 2404 may be a hard disk, a removable magnetic disk, a removable optical disk, magnetic cassettes or other magnetic storage devices, flash memory cards, CD-ROM, digital versatile disks (DVD) or other optical storage, random access memories (RAM), read-only memories (ROM), electrically erasable programmable read-only memory (EEPROM), and the like.

Any number of program components may be stored on the mass storage device 2404. An operating system 2405 and utterance software 2406 may be stored on the mass storage device 2404. One or more of the operating system 2405 and utterance software 2406 (or some combination thereof) may comprise program components and the utterance software 2406. Utterance data 2407 may also be stored on the mass storage device 2404. Utterance data 2407 may be stored in any of one or more databases known in the art. The databases may be centralized or distributed across multiple locations within the network 2415.

A user may enter commands and information into the computer 2401 via an input device (not shown). Such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices may be connected to the one or more processors 2403 via a human-machine interface 2402 that is coupled to the bus 2413, but may be connected by other interface and bus structures, such as a parallel port, game port, an IEEE 2494 Port (also known as a Firewire port), a serial port, network adapter 2408, and/or a universal serial bus (USB).

A display device 2411 may also be connected to the bus 2413 via an interface, such as a display adapter 2409. It is contemplated that the computer 2401 may have more than one display adapter 2409 and the computer 2401 may have more than one display device 2411. A display device 2411 may be a monitor, an LCD (Liquid Crystal Display), a light-emitting diode (LED) display, a television, a smart lens, smart glass, and/or a projector. In addition to the display device 2411, other output peripheral devices may comprise components such as speakers (not shown) and a printer (not shown) which may be connected to the computer 2401 via Input/Output Interface 2410. Any step and/or result of the methods may be output (or caused to be output) in any form to an output device. Such output may be any form of visual representation, including, but not limited to, textual, graphical, animation, audio, tactile, and the like. The display 2411 and computer 2401 may be part of one device, or separate devices.

The computer 2401 may operate in a networked environment using logical connections to one or more remote computing devices 2414A,B,C. A remote computing device 2414A,B,C may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network nodes, and so on. Logical connections between the computer 2401 and a remote computing device 2414A,B,C may be made via a network 2415, such as a local area network (LAN) and/or a general wide area network (WAN). Such network connections may be through a network adapter 2408. A network adapter 2408 may be implemented in both wired and wireless environments. Such networking environments are conventional and commonplace in dwellings, offices, enterprise-wide computer networks, intranets, and the Internet.

Application programs and other executable program components such as the operating system 2405 are shown herein as discrete blocks, although it is recognized that such programs and components may reside at various times in different storage components of the computing device 2401, and are executed by the one or more processors 2403 of the computer 2401. An implementation of utterance software 2406 may be stored on or sent across some form of computer-readable media. Any of the disclosed methods may be performed by processor-executable instructions embodied on computer-readable media.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification. It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
causing a first audio device to output an analog form of a pilot signal, wherein the first audio device is associated with a first clock;
causing a second audio device to convert the analog form of the pilot signal to a detected pilot signal, wherein the second audio device is associated with a second clock;
receiving, from the second audio device, the detected pilot signal;
determining, based on a digital form of the pilot signal and the detected pilot signal, a clock error; and
synchronizing, based on the clock error, the first clock and the second clock.

2. The method of claim 1, wherein the pilot signal comprises one or more of an audible frequency, or an inaudible frequency, and wherein the first audio device comprises a speaker and the second audio device comprises a microphone.

3. The method of claim 1, wherein the first clock is driven at the same frequency as the second clock, the method further comprising determining a phase trajectory difference between the digital form of the pilot signal and the detected pilot signal.

4. The method of claim 1, wherein determining the clock error is based on one or more of a zero-cross frequency estimate or a phase trajectory offset estimate.

5. The method of claim 1, wherein the first clock is associated with a first sample rate, wherein the second clock is associated with a second sample rate, and wherein the clock error indicates a difference between the first sampling rate and the second sampling rate.

6. The method of claim 1, wherein synchronizing the first clock and the second clock comprises resampling one or more of the first clock or the second clock based on the clock error.

7. The method of claim 1, further comprising:
sending, to a first audio device, a digital form of the pilot signal; and
causing the first audio device to convert the digital form of the pilot signal to the analog form of the pilot signal.

8. The method of claim 1, further comprising performing echo cancellation based synchronizing the first clock and the second clock.

9. A method comprising:
causing a first audio device to output an analog form of a pilot signal at a first frequency;
receiving, from a second audio device, a digital form of the pilot signal, wherein the digital form of the pilot signal comprises a second frequency associated with a sampling rate;
determining a difference between the first frequency and the second frequency;
determining, based on the difference between the first frequency and the second frequency, a clock error; and
updating, based on the clock error, the sampling rate.

10. The method of claim 9, wherein the pilot signal comprises one or more of: an audible frequency or an inaudible frequency.

11. The method of claim 9, wherein the first audio device comprises a speaker and is associated with a speaker clock and wherein the second audio device comprises a microphone and is associated with a microphone clock.

12. The method of claim 9, wherein determining the clock error is based on a zero-cross frequency estimate.

13. The method of claim 9, wherein determining the clock error is based on a phase trajectory offset estimate.

14. The method of claim 9, further comprising performing echo cancellation based on the adjusted sampling rate.

15. A method comprising:
causing a first audio device to output an analog form of a pilot signal at a first frequency;
receiving, from a second audio device, a digital form of the pilot signal, wherein the digital form of the pilot signal comprises a second frequency associated with a sampling rate;
determining, based on a difference between the first frequency and the second frequency, a clock error;
receiving, from the second audio device, one or more samples of audio output by the first audio device; and
buffering, based on the clock error, the one or more samples of audio.

16. The method of claim 15, wherein the pilot signal comprises one or more of: an audible frequency or an inaudible frequency.

17. The method of claim 15, wherein the first audio device comprises a speaker and is associated with a speaker clock and wherein the second audio device comprises a microphone and is associated with a microphone clock.

18. The method of claim 15, wherein the clock error is associated with the second audio device.

19. The method of claim 15, wherein determining the clock error is based on a zero-cross frequency estimate.

20. The method of claim 15, further comprising performing echo cancellation.
